(19) United States
(12) Patent Application Publication
(10) Pub. No.: US 2023/0232276 A1
(43) Pub. Date: Jul. 20, 2023

(54) COMMUNICATION APPARATUS AND COMMUNICATION METHOD FOR MULTI-LINK TRAFFIC INDICATION MAP

(71) Applicant: Panasonic Intellectual Property Corporation of America, Torrance, CA (US)

(72) Inventors: Rojan CHITRAKAR, Singapore (SG); Lei HUANG, Singapore (SG); Yoshio URABE, Nara (JP)

(21) Appl. No.: 18/000,813

(22) PCT Filed: Apr. 16, 2021
(86) PCT No.: PCT/SG2021/050221

§ 371 Date: Dec. 5, 2022

(30) Foreign Application Priority Data
Jun. 9, 2020 (SG) 10202005463Q

(51) Int. Cl. H04W 28/02; H04W 52/02

(52) U.S. Cl. CPC H04W 28/0278; H04W 52/0216; H04W 84/12

(57) ABSTRACT

The present disclosure provides communication apparatuses and methods for multi-link traffic indication map, the communication apparatus being an Access Point (AP) of a plurality of APs affiliated with an AP multi-link device (MLD), each of the plurality of APs operating in a corresponding link of the AP MLD, the AP comprising: circuitry, which in operation, generates a frame comprising a traffic indication map (TIM) element and a presence bitmap, the element comprising a partial virtual bitmap (PVM) indicating presence of one or more buffered units for one of a non-AP STA or a non-AP MLD associated with the AP or the AP MLD, the presence bitmap indicating whether additional information relating to the one or more BUs is present in the frame for the one of the non-AP STA or the non-AP MLD; and a transmitter, which in operation, transmits the frame in a link.

### BACKGROUND

### 1. Technical Field

The present embodiments generally relate to communication apparatuses, and more particularly relate to methods and apparatuses for multi-link traffic indication map.

### 2. Description of the Related Art

In today's world, communication devices are expected to wirelessly operate with the same capabilities as wired computing devices. For example, a user expects to be able to seamlessly watch a high definition movie streamed to the user's wireless communication device. This presents challenges for communication devices as well as the access points to which the communication devices wirelessly connect.

The Institute of Electrical and Electronics Engineers (IEEE) 802.11 group has recently formed the 802.11 Task Group (TG) to address these challenges. Multi-link operation in the 2.4 GHz, 5 GHz and 6 GHz frequency bands has been identified as a candidate technology for such communication. Multi-channel aggregation over multiple links is a natural way to create multi-fold increase in communication data throughput.

In multi-link operations between an access point (AP) multi-link device (MLD) and non-AP MLDs, a traffic indication map (TIM) element is carried in Beacon frames, TIM frames etc., to indicate buffered traffic (BU) for associated non-AP STAs operating in power save (PS) node. In multi-link operations, in contrast to single link operation, just the BU indication in the TIM element does not provide additional information regarding the BUs such as the recommended link to retrieve the BU, or the TID associated with the BU etc. While methods can be used to signal additional information about buffered BUs such as link mapping, link-set indication with link recommendation and TID (traffic identifier) etc., in order for non-AP MLDs to correctly figure out their position in the Link/TID information set, additional bitmaps are required for each bit set to 1 in the TIM element regardless of the method used as will be explained later.

There is thus a need for a communication apparatus and a communication method for multi-link traffic indication map to solve the above-mentioned issues and reduce the overhead required for signaling additional information about buffered BUs in WLAN networks that contain MLDs. Furthermore, other desirable features and characteristics will become apparent from the subsequent detailed description and the appended claims, taken in conjunction with the accompanying drawings and this background of the disclosure.

### SUMMARY

Non-limiting and exemplary embodiments facilitate providing communication apparatuses and communication methods for multi-link traffic indication map.

In a first embodiment, the present disclosure provides an access point (AP) of a plurality of APs affiliated with an AP multi-link device (MLD), each of the plurality of APs operating in a corresponding link of the AP MLD, the AP comprising: circuitry, which in operation, generates a frame comprising a traffic indication map (TIM) element and a presence bitmap, the element comprising a partial virtual bitmap (PVM) indicating presence of one or more buffered units for one of a non-AP STA or a non-AP MLD associated with the AP or the AP MLD, the presence bitmap indicating whether additional information relating to the one or more BUs is present in the frame for the one of the non-AP STA or the non-AP MLD; and a transmitter, which in operation, transmits the frame in a link.

In a second embodiment, the present disclosure provides a station (STA) of a plurality of STAs affiliated with a non-access-point (non-AP) multi-link device (MLD) associated with an AP MLD, each of the plurality of STAs operating in a corresponding link of the non-AP MLD, the STA comprising: a receiver, which in operation, receives a frame in a link, the frame comprising a traffic indication map (TIM) element and a presence bitmap, the element comprising a partial virtual bitmap (PVM) indicating presence of one or more buffered units for the non-AP MLD, the presence bitmap indicating whether additional information relating to the one or more BUs is present in the frame for the non-AP MLD; circuitry, which in operation, process the frame.

In a third embodiment, the present disclosure provides a communication method comprising: generating a frame comprising a traffic indication map (TIM) element and a presence bitmap, the element comprising a partial virtual bitmap (PVM) indicating presence of one or more buffered units for one of a non-AP STA or a non-AP MLD associated with the AP or the AP MLD, the presence bitmap indicating whether additional information relating to the one or more BUs is present in the frame for the one of the non-AP STA or the non-AP MLD; and transmitting the frame in a link.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments and to explain various principles and advantages in accordance with present embodiments.

FIG. 1 depicts a TIM element and Bitmap Control field of the TIM element.

FIG. 2 depicts a schematic diagram illustrating communications between an AP MLD and a non-AP MLD for multi-link power management and traffic indication.

FIG. 3 depicts a TIM bitmap and a set of Link mapping bitmap (LMBs).

FIG. 4 depicts a TIM bitmap and a link recommendation (LR) element.

FIG. 5 depicts a TIM bitmap 500 in a TIM element, a Multi-Link (ML)-TIM element and a LR element.

FIG. 6 depicts a TIM bitmap and a Traffic Identifier (TID) bitmap.

FIG. 7 depicts a TIM bitmap and a TID Indication.

FIG. 8 shows a schematic diagram illustrating an example configuration of a communication apparatus 800 in accordance with the present disclosure.

FIG. 9 depicts a flow chart illustrating a communication method for multi-link traffic map according to various embodiments of the present disclosure.

FIG. 10 depicts an example Beacon/TIM frame.

FIG. 11 depicts example associated identifier (AID) assignments and three example TIM bitmaps transmitted by an AP-MLD in the three links respectively.

FIG. 12 depicts an example TIM bitmap, an example LMB presence bitmap and an example LMB set in a TIM/Beacon frame.

FIG. 13 depicts an example TIM bitmap, an example LR presence bitmap and an example LR bitmap set in a TIM/Beacon frame.

FIG. 14 depicts an example TIM bitmap, an example Link-set presence bitmap and an example Link-set bitmap set and an example LR bitmap set in a TIM/Beacon frame.

FIG. 15 depicts an example a TIM bitmap, an example TID information presence bitmap and an example TID information bitmap set in a TIM/Beacon frame.

FIG. 16 depicts an example TIM bitmap, an example AC information presence bitmap and an example AC information bitmap set in a TIM/Beacon frame.

FIG. 17 depicts example AID assignments and three example TIM bitmaps transmitted in three links from an AP MLD respectively.

FIG. 18 depicts an example Beacon/TIM frame.

FIG. 19 depicts an example TIM bitmap and an example LMB set in a Beacon/TIM frame.

FIG. 20 depicts another example Beacon/TIM frame.

FIG. 21 depicts an example TIM bitmap, an example TID information presence bitmap and an example TID information bitmap set in a Beacon/TIM frame.

FIG. 22 depicts an example TIM bitmap transmitted in a link from an AP MLD and an example format of an AC information presence bitmap and an AC information bitmap set.

FIG. 23 depicts an example format of a TIM bitmap and a TID information presence bitmap 2304 and a TID information bitmap set in a Beacon/TIM frame.

FIG. 24 depicts an example format of Multi-link TIM element.

FIG. 25 depicts an example TIM bitmap and an example multi-link TIM bitmap, an example AC information presence bitmap and an example AC information bitmap set in a Beacon/TIM frame.

FIG. 26 depicts an example format of Multi-link TIM element including a Multi-link TIM bitmap.

FIG. 27 shows an example configuration of a communication device and two communication apparatuses affiliated with the communication device. The communication device is implemented as an AP MLD and each of the affiliated communication apparatuses may be implemented as an AP configured for multi-link traffic indication map in accordance with the present disclosure.

FIG. 28 shows an example configuration of a communication device and two communication apparatuses affiliated with the communication device. The communication device is implemented as a non-AP MLD and each of the affiliated communication apparatuses may be implemented as a STA configured for multi-link traffic indication map in according with the present disclosure.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

The following detailed description is merely exemplary in nature and is not intended to limit the embodiments or the application and uses of the embodiments. Furthermore, there is no intention to be bound by any theory presented in the preceding Background or this Detailed Description. Furthermore, other desirable features and characteristics will become apparent from the subsequent detailed description and the appended claims, taken in conjunction with the accompanying drawings and this background of the disclosure.

In the context of IEEE 802.11 (Wi-Fi) technologies, a station, which is interchangeably referred to as a STA, is a communication apparatus that has the capability to use the 802.11 protocol. Based on the IEEE 802.11-2020 definition, a STA can be any device that contains an IEEE 802.11-conformant media access control (MAC) and physical layer (PHY) interface to the wireless medium (WM).

For example, a STA may be a laptop, a desktop personal computer (PC), a personal digital assistant (PDA), an access point or a Wi-Fi phone in a wireless local area network (WLAN) environment. The STA may be fixed or mobile. In the WLAN environment, the terms “STA”, “wireless client”, “user”, “user device”, and “node” are often used interchangeably.

Likewise, an AP, which may be interchangeably referred to as a wireless access point (WAP) in the context of IEEE 802.11 (Wi-Fi) technologies, is a communication apparatus that allows STAs in a WLAN to connect to a wired network. The AP usually connects to a router (via a wired network) as a standalone device, but it can also be integrated with or employed in the router.

As mentioned above, a STA in a WLAN may work as an AP at a different occasion, and vice versa. This is because communication apparatuses in the context of IEEE 802.11 (Wi-Fi) technologies may include both STA hardware components and AP hardware components. In this manner, the communication apparatuses may switch between a STA mode and an AP mode, based on actual WLAN conditions and/or requirements.

In various embodiments of the present disclosure, a multi-link device (MLD) may refer to a device that operates in two or more frequency bands or links (2.4 GHz, 5 GHz or 6 GHz). The MLD may comprise two or more communication apparatus corresponding to the two or more links, each operating in a specific frequency band or link. For the sake of simplicity, each link of a MLD shown in the present disclosure relates to one of many communication apparatuses affiliated with the MLD which is primarily configured to operate in a specific frequency band (2.4 GHz, 5 GHz or 6 GHz) to transmit/receive signals to/from another communication apparatus that is not affiliated with the MLD operating also in that specific frequency band.

In various embodiments of the present disclosure, unless specified otherwise, a non-MLD STA, an 11n STAs, an 11ac STAs or an 11ax STA may refer to a legacy (HE/VHT/HT) STA or an EHT STA that is not affiliated with an MLD. Similarly, a non-MLD AP may refer to an EHT AP that is not affiliated with an MLD.

In various embodiments of the present disclosure, a partial virtual bitmap (PVM) field refers to a bitmap of a traffic indication map (TIM) element carried in frame transmitted by an AP or an AP MLD in a link, and the term “PVM” or “partial virtual bitmap” is used interchangeably with TIM bitmap.

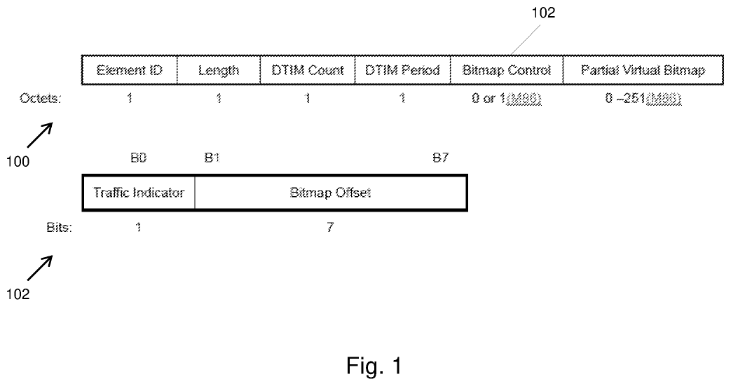

A traffic indication map (TIM) element is carried in Beacon frames to indicate buffered traffic (BU) for non-AP STAs operating in power save (PS) node. FIG. 1 depicts a TIM element and Bitmap Control field of the TIM element 100. The TIM element 100 comprises an Element identifier (ID) field, a Length field, a Delivery TIM (DTIM) Count field, a DTIM Period filed, a Bitmap Control field 102 and a Partial Virtual Bitmap (PVB) field. The Bitmap Control field 102 comprises a Traffic Indicator field and a Bitmap Offset field. The Length field is set to (N₁+N₂)+4 where N₁ is the largest even number such that bits numbered 1 to (N₁×8)−1 in the traffic indication virtual bitmap are all 0 and N₂ is the smallest number such that bits numbered (N₂+1)×8 to 2007 in the traffic indication virtual bitmap are all 0, N₁ and N₂ being used to signal the actual range of the TIM bitmap carried in the PVB field when the TIM bits at either end of the AID range are all set to 0. The PVB field is set to 1 for an AID to indicate a presence of buffered BUs for that AID. The traffic indicator is set to 1 in TIM elements with the DTIM Count field set to 0 when one or more group addressed media access control (MAC) service data unit (MSDUs)/MAC management protocol data units (MMPDUs) are buffered at the AP. TIM elements with the DTIM Count field set to 0 when one or more group addressed MSDUs/MMPDUs are buffered at the AP. The Bitmap Offset field contains number N₁/2.

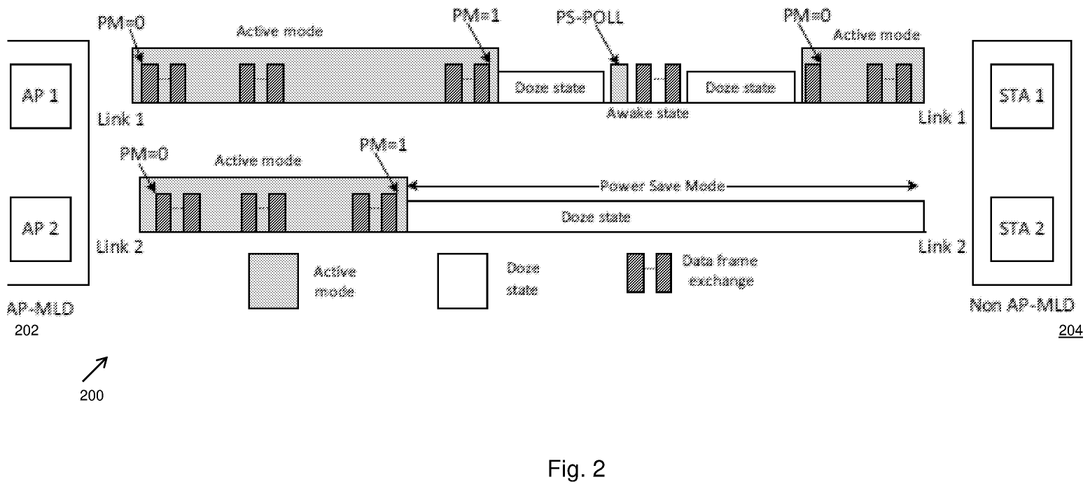

For multi-link power management, each STA of a non-AP MLD that is operating on an enabled link maintains its own power management mode and power states. Each STA of the non-AP MLD may change its power management mode or its power states independently. FIG. 2 depicts a schematic diagram 200 illustrating communications between an AP MLD 202 and a non-AP MLD 204 for multi-link power management and traffic indication. When a STA (e.g. STA 1, STA 2) of the non-AP MLD 204 operating on an enabled link are operating in the Active mode or in the Power Save mode awake state (e.g. configured under PM (power management mode) field value of 0), frame exchanges on that link are possible; whereas if AP MLD 202 has buffered traffic (BU) of an affiliated STA (e.g. STA 1, STA 2) of the associated non-AP MLD 204, the affiliated STA operating in the Power Save mode doze state (e.g. configured under PM (power management mode) field value of 1), the corresponding affiliated AP (e.g. AP 1, AP 2) on the AP MLD 202 will use the TIM element carried in Beacon frames to indicate the buffered traffic for the non-AP MLD 204.

TID-to-link mapping is a new mechanism introduced in 802.11be that allows an AP MLD and a non-AP MLD that has performed multi-link setup to determine how TIDs are mapped to the setup links in downlink (DL) and in uplink (UL). By default, all TIDs are mapped to all setup links for both UL and DL. If a TID is mapped to a link for a certain direction (DL/UL), transmission of the frames belonging to that TID is permitted in that direction.

A setup link is defined as enabled if at least one TID is mapped to that link and is defined as disabled if no TIDs is mapped to that link. At any point in time, a TID shall always be mapped to at least one setup link unless admission control is used. By default, as all TIDs are mapped to all setup links, all setup links are enabled.

If a TID is mapped in UL to a set of enabled links for a non-AP MLD, then the non-AP MLD can use any link within this set of enabled links to transmit frames carrying MSDUs or A-MSDUs (aggregated MSDUs) with that TID. If a TID is mapped in DL to a set of enabled links for a non-AP MLD, then the non-AP MLD can retrieve buffered BUs corresponding to that TID in any link within this set of enabled links while the AP MLD can use any link within this set of enabled links to transmit frames carrying MSDUs or A-MSDUs with that TID, subjected to existing restrictions for transmission of frames that apply to those enabled links.

Conventionally, TIM element is used as it is. For a non-AP MLD, a TIM bit is assigned per non-AP MLD regardless of the number of links setup, that is, a single AID is assigned to a non-AP MLD across all links. The TIM bit for a non-AP STA/MLD is set to 0 if the AP MLD does not have any buffered frame to transmit to the non-AP STA/MLD and is set to 1 if the AP MLD has one or more buffered frame to transmit to the non-AP STA/MLD on any link to be used. As per the IEEE 802.11-2020 specification, any value in the range 1-2007 can be used as an AID for associated STAs, however in various examples used in this disclosure, the AP MLD allocates AID to its associated non-AP STAs and non-AP MLDs in the AID range of 1-255.

On top of the conventional TIM element, another element, for example that carries a LMB, is defined to indicate the buffered data to link mapping for each non-AP MLD that has its TIM bit set to 1.

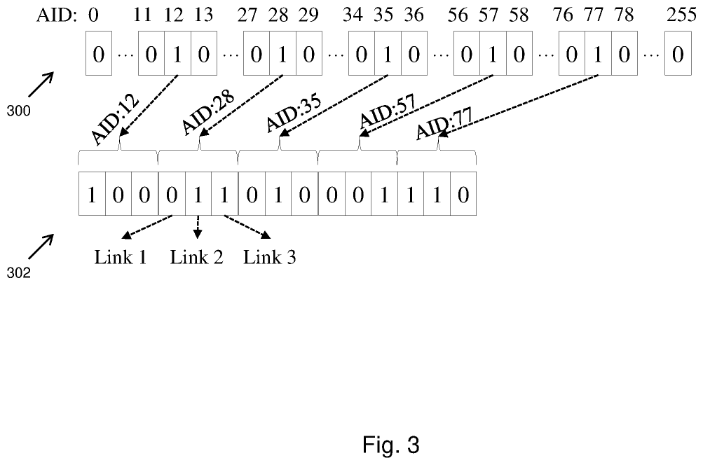

FIG. 3 depicts a TIM bitmap 300 in a TIM element and a set of LMBs 302. Each bit in the TIM bitmap, except AID 0, corresponds to a non-AP STA/MLD's AID. TIM bits corresponding to AIDs of 12, 28, 35, 57 and 77 are set to 1 indicating that the AP MLD has one or more buffered frame to transmit to the corresponding STAs/MLDs associated with the AIDs. One LMB exists for each bit set to 1 in the TIM bitmap 300. This is for non-AP MLDs to calculate its position of their LMB in the LMB set 302 based on the order of bits set to 1 in the TIM bitmap 300. Conventionally, LMB is needed even for a legacy STA to ensure non-AP MLDs can correctly find their LMB since it is not possible to identify legacy STAs based on the TIM bitmap 300. In one example, the number of bits in one LMB corresponds to the number of enabled links for the non-AP MLD.

When a non-AP MLD identifies in the TIM element that the TIM bit corresponding to the non-AP MLD's AID is set to 1, the non-AP MLD further checks the LMB corresponding to the AID and identifies the specific link(s) that the buffered traffic is mapped to. For example, the non-AP MLD with an AID of 28 identifies its TIM bit is set to 1 and thus the AP MLD has its buffered traffic in one of its enabled links. The non-AP MLD then identifies its LMB is second in order (second bit set to 1 in the TIM bitmap) and checks the second LMB in the set of LMBs 302. The non-AP MLD then identifies that the second bit and third bit of its LMB are set to 1 indicating the AP MLD has buffered traffic for the non-AP MLD in Link 2 and Link 3.

In another conventional example, AID is assigned to a non-AP MLD, and a TIM element indicates BU status of each non-AP MLD. Under default TID-to-link mapping, TIDs are mapped to all enabled links. When the bit in TIM element corresponding to a non-AP MLD's AID is set to 1, although the non-AP MLD can retrieve buffered data through any link of the enabled links, the AP MLD may use a LR element to indicate a recommended link(s). A bitmap is assigned to a non-AP MLD in the LR element, in which each bit of the bitmap is mapped to a link and indicates whether use of the link is recommended.

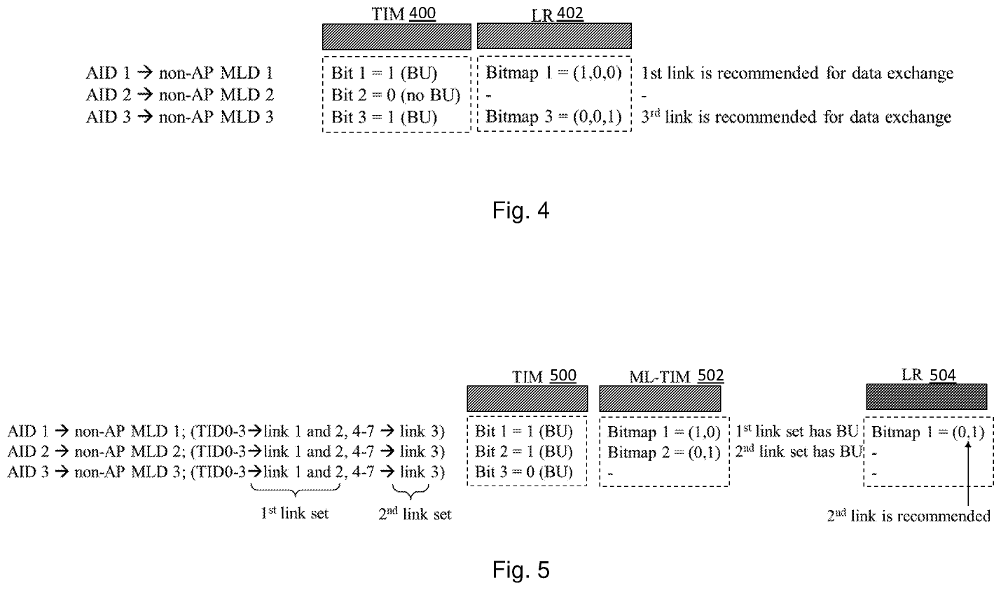

FIG. 4 depicts a TIM bitmap 400 and a LR element 402. In the TIM bitmap 400, TIM bits (bits 1 and 3) associated with non-AP MLD 1's and non-AP MLD 3's AIDs are set to 1, indicating the AP MLD has one or more buffered frame to transmit to the non-AP MLD 1 and non-AP MLD 3. The LR element 402 comprises a bitmap for each bit set to 1 in the TIM element 400, in this case Bitmap 1 and Bitmap 3 to indicate a recommended link for non-AP MLD 1 and non-AP MLD 3 respectively. In one example, the number of bits in a LR bitmap corresponds to the number of enabled links for the non-AP MLD. Bitmap 1 has a value of “1”, “0” and “0” indicating that 1^{st} link is recommended for non-AP MLD to retrieve the buffered frames from the AP MLD; and Bitmap 3 has a value of “0”, “0” and “1” indicating that 3^{rd} link is recommended for non-AP MLD 3 to retrieve the buffered frames from the AP MLD.

Besides the default TID-to-link mapping, two or more links may be categorized under one set of links and different TIDs may also be mapped to different sets of links. By using a new multi-link (ML) TIM element, BU status of different link sets can be indicated. A bitmap in the ML TIM element is assigned to a non-AP MLD. Each bit of the bitmap is mapped to a link set and indicates BU status, for example set to 1 if there is one or more BUs and set to 0 if there is no BU for the link set. LR element may also be used to indicate a recommended link within a link set.

FIG. 5 depicts a TIM bitmap 500, a ML-TIM element 502 and a LR element 504. TIDs 0-3 are mapped to a first set of links consisting of link 1 and link 2 while TIDs 4-7 are mapped to a second set of links consisting of link 3. TIM bits (bits 1 and 2) corresponding to non-AP MLD 1's and non-AP MLD 2's AIDs are set to 1, indicating the AP MLD has one or more buffered frame to transmit to the non-AP MLD 1 and non-AP MLD 2. The ML-TIM element 502 comprises a bitmap for each bit set to 1 in the TIM element, in this case Bitmap 1 and Bitmap 2 to indicate BU status of different link sets for non-AP MLD 1 and non-AP MLD 2 respectively. The number of bits in a ML-TIM bitmap 502 corresponds to the number of link sets. Bitmap 1 has a value of “1” and “0” indicating that 1^{st} link set has BU for non-AP MLD 1; and Bitmap 2 has a value of “0” and “1” indicating that 2^{nd} link set has BU for non-AP MLD 2.

The LR element 504 further comprises a bitmap indicate a recommended link within a link set, Bitmap 1 having a value of “0” and “1” indicating a recommended link in 2^{nd} link of link set 1, i.e. link 2 for non-AP MLD 1. Since Bitmap 2 indicates 2^{nd} link set for non-AP MLD 2 and the 2^{nd} link set only contains a single link (link 3), link 3 is recommended for non-AP MLD2 and a separate LR element is not required.

Yet in another conventional example, an AID is assigned to a non-AP MLD and a TIM element indicates BU status of each non-AP MLD. A TID bitmap (8 bits per TID) for each bit set to 1 for a non-AP MLD in the TIM element indicates the TID(s) for which AP MLD has one or more BUs for a non-AP MLD. Each bit in the TID bitmap represents one TID starting from TID 0 and a bit set to 1 indicates that buffered frames belonging to the corresponding TID exists at the AP MLD. The STA uses TID-to-link mapping to determine which link(s) it should wake up to retrieve the buffered MPDUs (MAC protocol data unit). In this example it is assumed that different TIDs are mapped to different links.

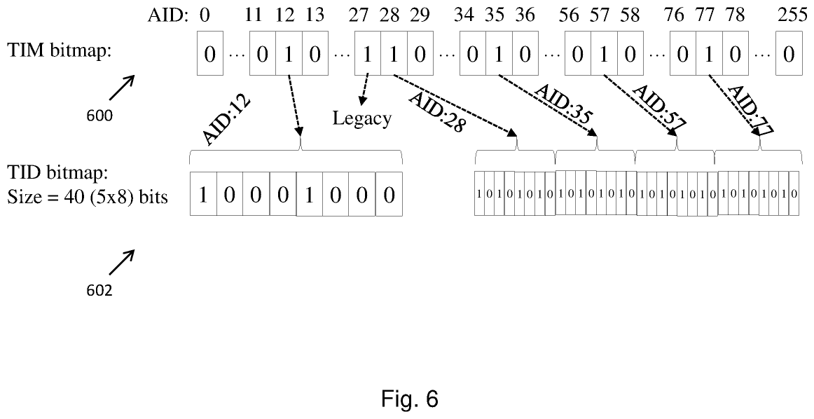

FIG. 6 depicts a TIM bitmap 600 in a TIM element and a TID bitmap 602. In the TIM bitmap 600, TIM bits corresponding to one non-AP STA under an AID of 27 and five non-AP MLDs under AIDs of 12, 28, 35, 57 and 77 are set to 1 indicating that the AP MLD has one or more buffered frame to transmit to the corresponding STA and MLDs respectively. An 8-bit TID exists for each TIM bit for non-AP MLD set to 1 in the TIM element. In this case, the TID bitmap 602 comprises five 8-bit TID for five respective non-AP MLDs to which the AP MLD has one or more buffered frame to transmit. The 8-bit TIDs will be used by the respective non-AP MLDs to determine which link(s) they should wake up to retrieve the buffered MPDUs from the AP MLD. However, in this example, it is not clear whether the TID indication is also required for the legacy non-AP STA with AID 27; without it, non-AP MLDs with AID greater than 27 will not be able to identify the correct TID indication for themselves.

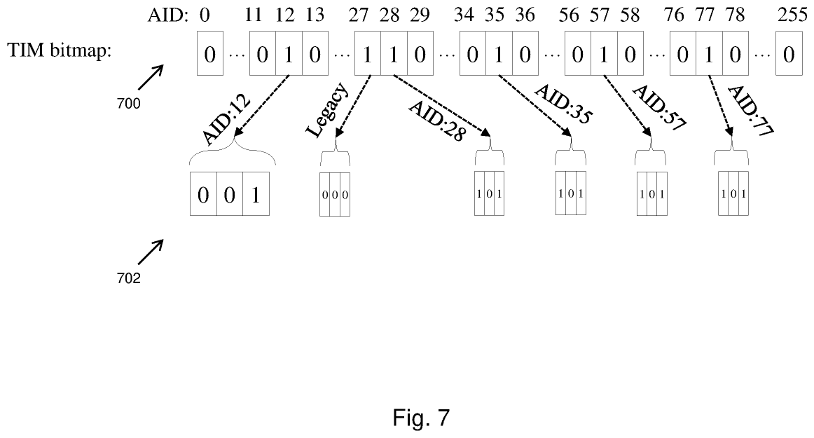

Alternatively, the AP signals a single TID using 3 bits rather than an 8-bit TID bitmap 602. FIG. 7 depicts a TIM bitmap 700 in a TIM element and a TID 702. A 3-bit TID is signalled to each STA/MLD which AID corresponding to TIM bit which is set to 1, and if frames belonging to multiple TIDs are buffered at the AP MLD for a non-AP MLD, the TID that is signalled may be based on certain implementation specific criteria. The AP delivers MPDUs belonging to the indicated TIP on the link where the STA/MLD wakes up and an A-Control (TID control) field is carried in the MPDUs that signals additional TIDs for which the AP has BUs for the non-AP MLD. Attention is drawn to the fact that TID indication is also required for a legacy STA so as to enable non-AP MLDs to find the correct TID indication even though the legacy STA will not be aware of the TID indication.

As mentioned earlier, regardless of the method used to signal additional information about buffered BUs (e.g. link mapping, link-set indication with link recommendation and TID indication as illustrated in FIGS. 3-7), additional bitmap are required for each bit set to 1 in the TIM element (including legacy STAs and non-MLD EHT STAs) in order for non-AP MLDs to correctly figure out their position in the Link/TID information set. There is thus a need for a communication apparatus and a communication method for multi-link traffic indication map to solve the above-mentioned issues and reduce the overhead required for signaling additional information about buffered BUs in WLAN networks that contains MLDs.

According to the present disclosures, two solutions are proposed. In particular, a presence bitmap is carried in Beacon/TIM/FILS Discovery/OPS frame to indicate whether a corresponding Link/TID/AC information related to buffered BUs for a non-AP STA/MLD exists in the Link/TID/AC information set. The presence bitmap may still carry implicit information about the link even if the bit is set to 0.

Further, a “Starting AID” field is carried in Beacon/TIM/FILS Discovery/OPS frame to indicate the smallest AID associated with a non-AP MLD (e.g. AID of the first non-AP MLD) for which Link/TID/AC information is included in the Link/TID/AC information set. Different portions (e.g. AID spaces) may be reserved for assignment of AIDs to legacy STAs/non-MLD Extremely High Throughput (EHT) STAs and AIDs assigned to non-AP MLDs to further reduce the overhead of the Link/TID/AC information set.

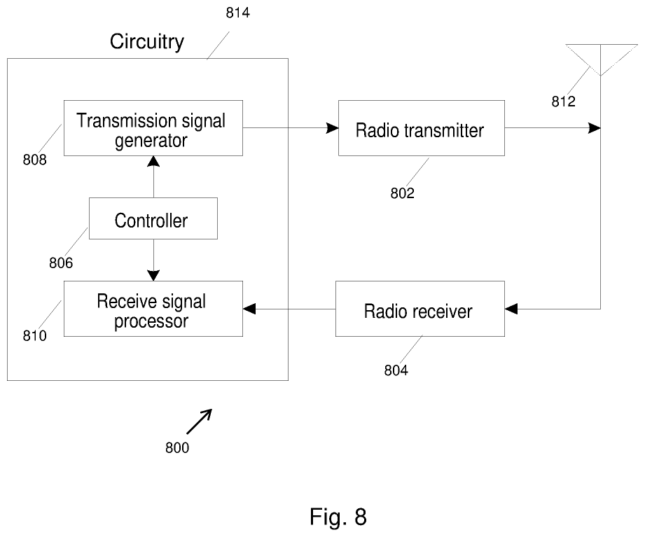

FIG. 8 shows a schematic diagram illustrating an example configuration of a communication apparatus 800 in accordance with the present disclosure. The communication apparatus 800 may be implemented as an AP and a STA and configured for multi-link traffic indication map in accordance with the present disclosure. As shown in FIG. 8, the communication apparatus 800 may include circuitry 814, at least one radio transmitter 802, at least one radio receiver 804, and at least one antenna 812 (for the sake of simplicity, only one antenna is depicted in FIG. 8 for illustration purposes). The circuitry 814 may include at least one controller 806 for use in software and hardware aided execution of tasks that the at least one controller 806 is designed to perform, including control of communications with one or more other communication apparatuses in a multiple input and multiple output (MIM0) wireless network. The circuitry 814 may furthermore include at least one transmission signal generator 808 and at least one receive signal processor 810. The at least one controller 806 may control the at least one transmission signal generator 808 for generating MAC frames (for example Data frames, Management frame and Action frames) to be sent through the at least one radio transmitter 802 and the at least one receive signal processors 810 for processing MAC frames (for example Data frames, Management frame and Action frames) received through the at least one radio receiver 804 from the one or more other communication apparatuses. The at least one transmission signal generator 808 and the at least one receive signal processor 810 may be stand-alone modules of the communication apparatus 800 that communicate with the at least one controller 806 for the above-mentioned functions, as shown in FIG. 8. Alternatively, the at least one transmission signal generator 808 and the at least one receive signal processor 810 may be included in the at least one controller 806. It is appreciable to those skilled in the art that the arrangement of these functional modules is flexible and may vary depending on the practical needs and/or requirements. The data processing, storage and other relevant control apparatus can be provided on an appropriate circuit board and/or in chipsets. In various embodiments, when in operation, the at least one radio transmitter 802, at least one radio receiver 804, and at least one antenna 812 may be controlled by the at least one controller 806.

The communication apparatus 800, when in operation, provides functions required for multi-link traffic indication map. For example, the communication apparatus 800 may be an AP of a plurality of APs affiliated with an AP MLD where each of the plurality of APs operating in a corresponding link of the AP MLD, and the circuitry (for example the at least one transmission signal generator 808 of the circuitry 814) may, in operation, generate a frame comprising a traffic indication map (TIM) element and a presence bitmap, the element comprising a partial virtual bitmap (PVM) indicating presence of one or more buffered units for one of a non-AP STA or a non-AP MLD associated with the AP or the AP MLD, the presence bitmap indicating whether additional information relating to the one or more BUs is present in the frame for the one of the non-AP STA or the non-AP MLD. The ratio transmitter 802 may, in operation, transmit the frame in a link.

For example, the communication apparatus 800 may be a STA of a plurality of STAs affiliated with an non-AP MLD associated with an AP MLD, each of the plurality of STAs operating in a corresponding link of the non-AP MLD, and the radio receiver 804 may, in operation, receives a frame on a link, the frame comprising a traffic indication map (TIM) element and a presence bitmap, the element comprising a partial virtual bitmap (PVM) indicating presence of one or more buffered units for the non-AP MLD, the presence bitmap indicating whether additional information relating to the one or more BUs is present in the frame for the non-AP MLD. The circuitry (for example the at least one receive signal processor 810 of the circuitry 814) may, in operation, process the frame.

In an embodiment, the frame transmitted/received by the communication apparatus 800 further comprises a starting associated identifier (AID) indicating a smallest AID for which additional information relating to one or more BUs is present in the frame. Yet in another embodiment, a first portion of the PVM in the TIM element is associated with AIDs assigned to legacy STAs and on-MLD EHT STAs and a second portion of the PVM in the TIM element is associated with AIDs assigned to non-AP MLDs, wherein the first portion and the second portion of the TIM element do not overlap.

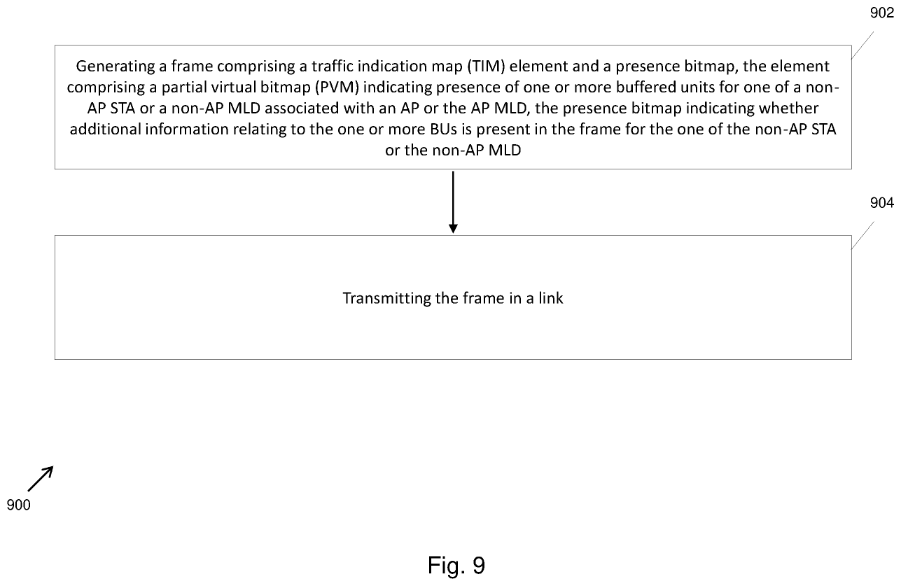

FIG. 9 depicts a flow chart 900 illustrating a communication method for multi-link traffic map according to various embodiments of the present disclosure. In step 902, a step of generating a frame comprising a traffic indication map (TIM) element and a presence bitmap is carried out, the element comprising a partial virtual bitmap (PVM) indicating presence of one or more buffered units for one of a non-AP STA or a non-AP MLD associated with an AP or an AP MLD, the presence bitmap indicating whether additional information relating to the one or more BUs is present in the frame for the one of the non-AP STA or the non-AP MLD. In step 904, a step of transmitting the frame in a link is carried out.

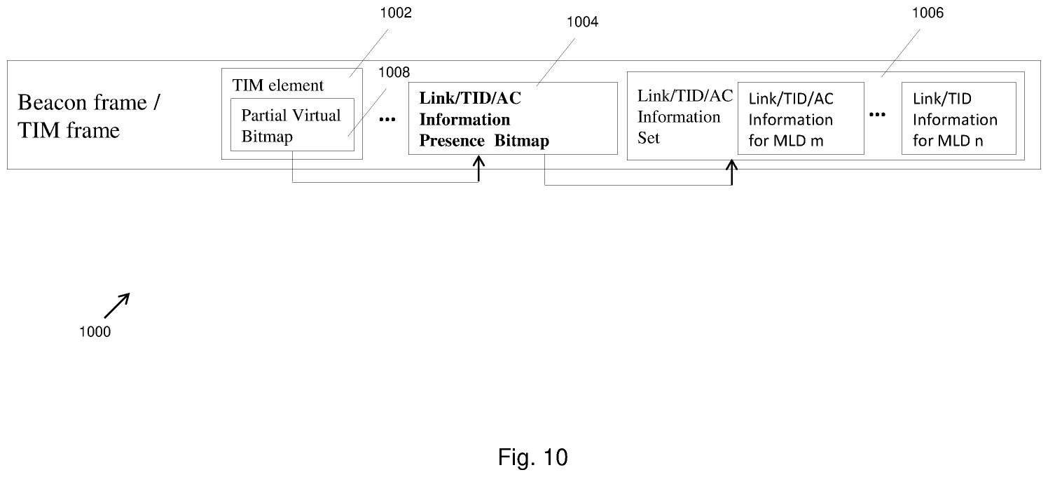

FIG. 10 depicts an example Beacon/TIM frame 1000. Although the format of Beacon/TIM frame is illustrated, it is appreciable that the same can be applied to a Fast Initial Link Setup (FILS) Discovery frame or an Operation (OPS) frame. The Beacon/TIM frame 1000 carries a TIM element 1002 comprising a Partial Virtual Bitmap (PVM) 1008, a Link/TID/AC Information Presence Bitmap 1004, a Link/TID/AC Information Set 1006 comprising Link/RID/AC information for each of associated MLDs. The Presence Bitmap 1004 indicates whether a corresponding Link/TID/AC information related to buffered BUs for a non-AP MLD exists in the Link/TID/AC information set 1004.

The Presence Bitmap 1004 carries 1 bit for every bit set to 1 in the TIM element 1002 in the same order as in the PVB 1008. A bit in the Presence Bitmap 1004 is set to 1 if the corresponding entry of Link/TID/AC information exists in the Link/TID/AC information set 1006; else it is set to 0.

Bits corresponding to legacy STAs are always set to 0; whereas bits corresponding to MLDs are set to 1 if the Link/TID/AC information exists for the MLDs in the Link/TID/AC information set 1006, for example, if the AP MLD has BUs buffered in other links for the non-AP MLDs, or if the AP MLD recommends non-AP MLDs to retrieve BUs in another link, or if the AP MLD needs to signal BUs of TIDs that are mapped to other links; and are set to 0 otherwise, for example, if the AP MLD has BU buffered for the non-AP MLDs in the same link in which the TIM/Beacon frame 1000 carrying the TIM element is transmitted (herein referred to as “current link”, or it may also be referred to as the “transmitting link”), or if the AP MLD recommends the non-AP MLDs to retrieve BUs in current link, or if all the BUs for the non-AP MLDs belong to TIDs that are exclusively mapped to current link, or for a single link EHT STA or a single link non-AP MLD that only listens for Beacon on one link, its bit is set to 0 in all links. Advantageously, bits set to 0 still carry implicit information about the current link and Link/TID/AC information only exists for MLDs that require them. With the Presence Bitmap 1004 in the Beacon/TIM frame 1000, a non-AP MLD is then configured to check its corresponding bit in the Presence Bitmap 1004 if its corresponding bit in the PVB 1008 is set to 1, and if its bit is set to 1 in the Presence Bitmap 1004, it then further checks the corresponding entry in the Link/TID/AC Information set 1006 for further information about the BU relating to Link/TID/AC.

According to the present disclosure, a same AID is assigned to an MLD across all links but a unique AID is assigned to a legacy in each link, i.e. the same AID may be assigned to different legacy STAs in different links. Advantageously, there is no restrictions on how the AIDs are assigned by an AP MLD.

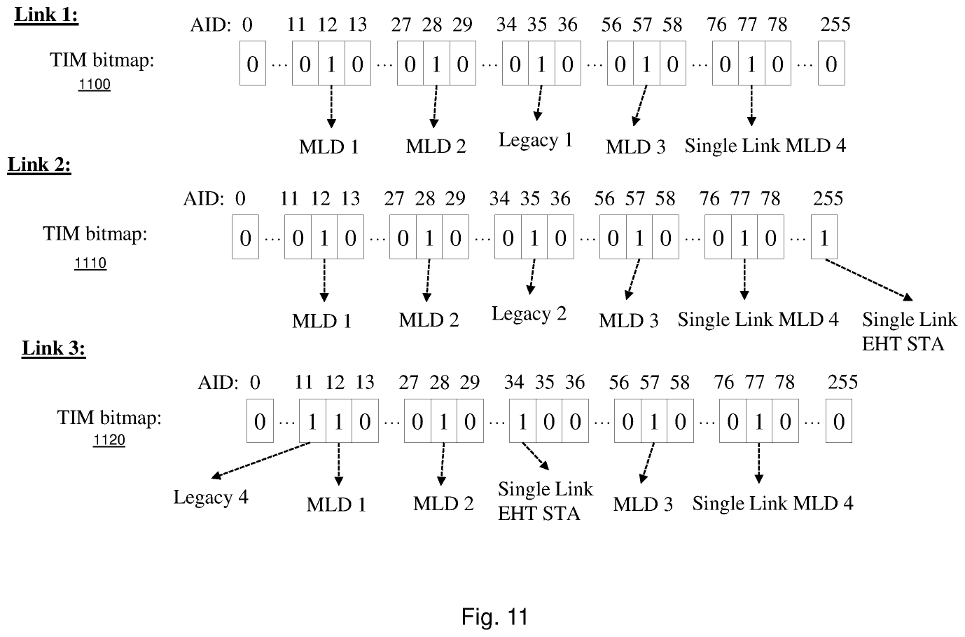

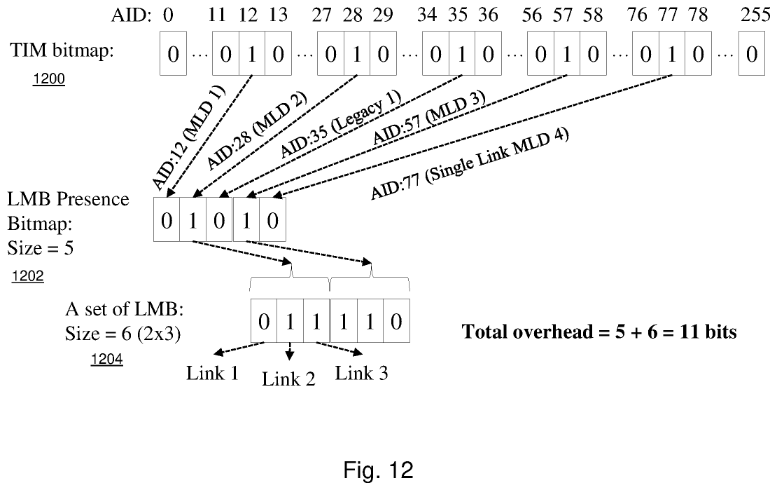

FIG. 11 depicts example AID assignments and three examples TIM bitmaps 1100, 1110, 1120 transmitted by an AP-MLD in three links respectively. MLDs 1, 2 3 operating in all three links (Link 1, Link 2, Link 3) as well as single link MLD 4 are assigned to same AIDs of 12, 28, 57, 77 respectively across three links; while legacy STAs are assigned to a unique AID in their respective operating links. Notably, a same AID of 35 in Link 1 and Link 2 is assigned to different legacy STAs (Legacy 1 and Legacy 2) respectively while AID 35 is not assigned in Link 3. Various embodiments of the present disclosure in the following descriptions with the accompanying FIGS. 12-16 are based on the example AID assignment used for the example TIM bitmap 1100.

In one embodiment, the presence bitmap 1004 shown in FIG. 10 can be a Link mapping bitmap (LMB) and the Link/TID/AC information set 1006 shown in FIG. 10 is a LMB set where the presence bitmap indicates whether a corresponding LMB exists in the LMB set. Bits corresponding to legacy STAs are always set to 0; whereas bits corresponding to MLDs are set to 0 if the BUs are only available on the link in which the TIM/Beacon frame carrying the TIM element is transmitted, for example due to TID-to-link mapping or the MLD only operates on that link etc., and are set to 1 if the BUs are also available on other links. The LMB presence bitmap carries a bit for every bit set to 1 in the TIM bitmap in the same order as in the TIM bitmap and the LMB set carries a LMB for every bit set to 1 in the LMB presence bitmap in the same order as in the LMB presence bitmap. Advantageously, a bit set to 0 in the LMB presence bitmap indicate that the corresponding non-AP MLD only needs to retrieve BUs in the current link and no LMB is required in the LMB set, the overhead of Link/TID/AC information is reduced.

FIG. 12 depicts an example TIM bitmap 1200, an example LMB presence bitmap 1202 and an example LMB set 1204 in a TIM/Beacon frame. In the TIM bitmap 1200, TIM bits corresponding to AIDs of 12, 28, 35, 57 and 77 assigned to MLD 1, MLD 2, Legacy 1, MLD 3 and Single Link MLD 4 respectively are set to 1 indicating that the AP MLD has one or more buffered frame to transmit to those STA/MLDs. The LMB presence bitmap 1202 carries a bit for every bit set to 1 in the TIM bitmap 1200 in the same order as in the TIM bitmap 1200, hence the LMB presence bitmap 1202 has a total size of five bits.

In this example, AP MLD transmitting the TIM/Beacon frame operates in three links (Link 1, Link 2 and Link 3) and the TIM/Beacon frame transmitted in Link 1 (herein referred to current link) is illustrated. MLD 1 only has BUs of TIDs mapped to Link 1 while MLD 4 only operates on Link 1 in this example. As BUs of TIDs for MLD 1 and MLD 4 are mapped to the current link (Link 1), no additional information for MLD1 and MLD 4 is required and LMB only exists or required for MLD 2 and MLD 3 in the LMB set. The first bit and the fifth bit of the LMB presence bitmap 1202 corresponding to MLD 1 and MLD 4 are set to 0 to indicate that the BUs are only available on the current link (Link 1); whereas the second bit and the fourth bit of the LMB presence bitmap 1202 corresponding to MLD 2 and MLD 3 are set to 1 to indicate that their BUs are also available on the other link (Link 2, Link 3). Legacy 1 is a legacy STA, therefore the third bit of the LMB presence bitmap 1202 corresponding to Legacy 1 is always set to 0.

The LMB set 1204 carries a LMB for every bit set to 1 in the LMB presence bitmap 1202 in the same order as in the LMB presence bitmap 1202. In this case, each LMB comprises three bits corresponding to three different links (Link 1, Link 2, Link 3), hence the LMB set 1204 has a total size of six bits. A bit in a LMB corresponding to a MLD is set to 1 to indicate that the BUs are available in the corresponding link. In this case, the first LMB of the LMB set 1204 corresponding to MLD 2 has its second bit and third bit set to 1 indicating the BUs for MLD 2 are available in Link 2 and Link 3. In this example, the total overhead of Link/TID/AC information using LMB presence bitmap 1202 (five bits) and LMB set 1204 (six bits) is 11 bits.

In another embodiment, the presence bitmap 1004 can be a Link Recommendation (LR) presence bitmap and the Link/TID/AC information set 1006 is a LR bitmap set. For default TID-to-link mapping where TIDs are mapped to all enabled links, the LR presence bitmap indicates whether a corresponding LR bitmap exists in the LR bitmap set. Bits corresponding to MLDs are set to 0 if the link in which the TIM/Beacon frame carrying the TIM element is transmitted is recommended, or AP MLD has no link recommendation; and set to 1 if a link other than the current link is recommended.

The LR presence bitmap carries a bit for every bit set to 1 in the TIM bitmap in the same order as in the TIM bitmap and the LR bitmap set carries a LR bitmap for every bit set to 1 in the LR presence bitmap in the same order as in the LR presence bitmap. Unlike LMB, the current link is excluded from LR bitmap since the current link can be recommended by setting the corresponding bit in the LR Present Bitmap to 0. Advantageously, a bit set to 0 in the LR presence bitmap indicate that the corresponding non-AP MLD only needs to retrieve BUs in the current link and no LR bitmap is required in the LR bitmap set, the overhead of Link/TID/AC information is reduced.

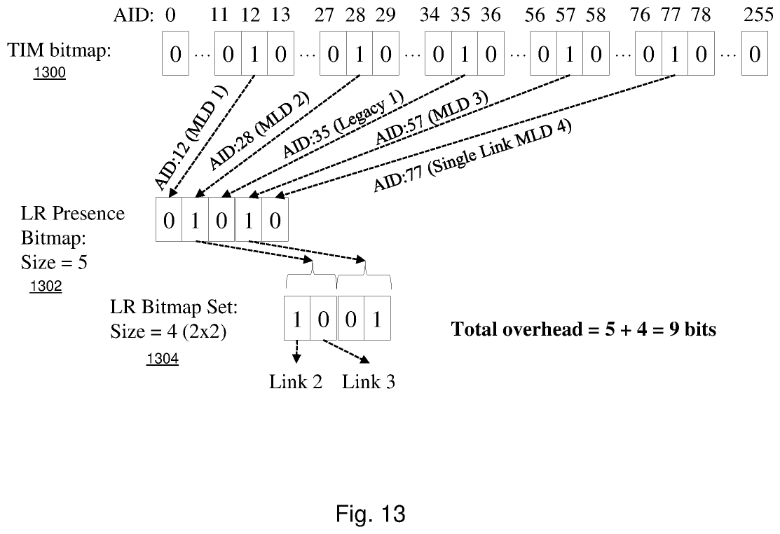

FIG. 13 depicts an example TIM bitmap 1300, an example LR presence bitmap 1302 and an example LR bitmap set 1304 in a TIM/Beacon frame. In the TIM bitmap 1300, TIM bits corresponding to AIDs of 12, 28, 35, 57 and 77 assigned to MLD 1, MLD 2, Legacy 1, MLD 3 and Single Link MLD 4 respectively are set to 1 indicating that the AP MLD has one or more buffered frame to transmit to those STA/MLDs. The LR presence bitmap 1302 carries a bit for every bit set to 1 in the TIM bitmap 1300 in the same order as in the TIM bitmap 1300, hence the LR presence bitmap 1302 has a total size of five bits.

In this example, AP MLD transmitting the TIM/Beacon frame operates in three links (Link 1, Link 2 and Link 3) and the TIM/Beacon frame is transmitted in Link 1 (herein referred to current link). MLD 1 only has BUs of TIDs mapped to Link 1 while MLD 4 only operates on Link 1. As BUs of TIDs for MLD 1 and MLD 4 are mapped to the current link (Link 1), no additional information for MLD1 and MLD 4 is required and LR bitmap only exists or required for MLD 2 and MLD 3 in the LR bitmap set 1304. The first bit and the fifth bit of the LR presence bitmap 1302 corresponding to MLD 1 and MLD 4 are set to 0 to indicate that the BUs are only available on the current link (Link 1); whereas the second bit and the fourth bit of the LR presence bitmap 1302 corresponding to MLD 2 and MLD 3 are set to 1 to indicate that their BUs are also available on the other link (Link 2, Link 3). Legacy 1 is a legacy STA, therefore the third bit of the LR presence bitmap 1302 corresponding to Legacy 1 is always set to 0.

The LR bitmap set 1304 carries a LR for every bit set to 1 in the LR presence bitmap 1202 in the same order as in the LR presence bitmap 1202. In this case, each LR bitmap comprises two bits corresponding to two different links (Link 2, Link 3) other than the current link (Link 1), hence the LR bitmap set 1304 has a total size of four bits. A bit in a LR bitmap corresponding to a MLD is set to 1 to indicate that the BUs in a link other than the current link is recommended. In this case, the first LR bitmap of the LR bitmap set 1304 is associated with MLD 2 and has its first bit set to 1 indicating that Link 2 is recommended for MLD 2 and the second LR bitmap of the LR bitmap set 1304 is associated with MLD 3 and has its second bit set to 1 indicating that Link 3 is recommended for MLD 3. The total overhead of Link/TID/AC information using LR presence bitmap 1302 (five bits) and LR set1304 (four bits) is nine bits.

Besides used of LR presence bitmap and LR bitmap set in default TID-to-link mapping, they can also be used when different TIDs are mapped to different sets of links where one or more links of enabled links may be categorized into a link set. In such cases, the presence bitmap can be a Link-set presence bitmap bitmap and the Link/TID/AC information set is a Link-set bitmap set. The Link-set presence bitmap indicates whether a corresponding Link-set bitmap exists in the Link-set bitmap set. Bits corresponding to MLDs are set to 0 if the link in which the TIM/Beacon frame carrying the TIM element is transmitted is the only link in a link-set and there are BUs only for this link-set; and set to 1 if there are BUs for other link-sets.

The Link-set presence bitmap carries a bit for every bit set to 1 in the TIM bitmap in the same order as in the TIM bitmap and the Link-set bitmap set carries a Link-set bitmap for every bit set to 1 in the Link-set presence bitmap in the same order as in the Link-set presence bitmap. A LR bitmap set may be further used a bit set to 1 in the Link-set bitmap set to indicate which link in the link set in which the BUs exist.

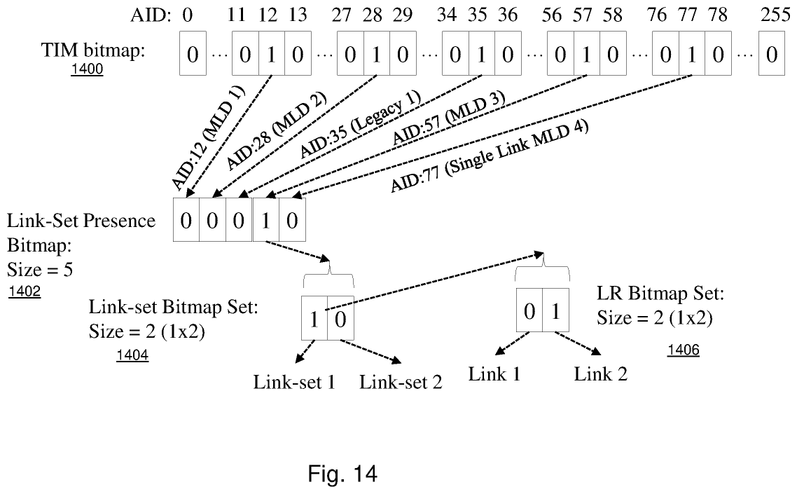

FIG. 14 depicts an example TIM bitmap 1400, an example Link-set presence bitmap 1402 and an example Link-set bitmap set 1404 and a LR bitmap set 1406. In the TIM bitmap 1400, TIM bits corresponding to AIDs of 12, 28, 35, 57 and 77 assigned to MLD 1, MLD 2, Legacy 1, MLD 3 and Single Link MLD 4 respectively are set to 1 indicating that the AP MLD has one or more buffered frame to transmit to those STA/MLDs. The Link-set presence bitmap 1402 carries a bit for every bit set to 1 in the TIM bitmap 1400 in the same order as in the TIM bitmap 1400, hence the Link-set presence bitmap 1402 has a total size of five bits.

In this example, AP MLD transmitting the TIM/Beacon frame operates in three links (Link 1, Link 2 and Link 3) and the TIM/Beacon frame is transmitted in Link 3 (herein referred to current link or current link set). TIDs 0-3 are mapped to Link 1 and Link 2, hence Link 1 and Link 2 can be categorized into a link set (link-set 1), and TIDs 4-7 are mapped Link 3 categorized as another link set (link-set 2). MLD 1 and MLD 2 only has only has BUs of TIDs mapped to link-set 2 (i.e. Link 3) while MLD 4 only operates on Link 3. As BUs of TIDs for MLD 1, MLD 2, MLD 4 are mapped to the current link set (Link-set 2 or Link 3), no additional information for MLD1, MLD2 and MLD 4 is required and Link-set bitmap only exists or required for MLD 3 in the Link-set bitmap set 1404. The first bit, second bit and the fifth bit of the Link-set presence bitmap 1402 corresponding to MLD 1, MLD 2 and MLD 4 are set to 0 to indicate that the BUs are only available on the current link set; whereas the fourth bit of the Link-set presence bitmap 1402 corresponding to MLD 3 is set to 1 to indicate that the BUs are also available on the other link-set (Link-set 1). Legacy 1 is a legacy STA, therefore the third bit of the Link-set presence bitmap 1402 corresponding to Legacy 1 is always set to 0.

The Link-set bitmap set 1404 carries a Link-set bitmap for every bit set to 1 in the Link-set presence bitmap 1402 in the same order as in the Link-set presence bitmap 1402. In this case, each Link-set bitmap comprises two bits corresponding to two different link sets (Link-set 1, Link-set 2), hence the Link-set bitmap set 1404 (comprising only one Link-set bitmap) has a total size of two bits. A bit in a Link-set bitmap corresponding to a MLD is set to 1 to indicate that the BUs exist in that link set. In this case, the first bit of the Link-set bitmap set associated with MLD 3 is set to 1 indicating that the BUs for MLD 3 exists in Link-set 1. The LR bitmap set 1406 carries a LR bitmap for every bit set to 1 in the Link-set bitmap set 1404. A bit in a LR bitmap corresponding to a link of a link set to indicate that the BUs is in that link of the link set. In this case, the LR bitmap of the LR bitmap set 1406 associated with MLD 3 has its first bit set to 1 indicating that there are BUs in Link 1 of Link-set 1. The total overhead of Link/TID/AC information using Link-set presence bitmap 1402 (five bits), Link-set Bitmap set 1404 (four bits) and LR Bitmap set 1406 (two bits) is nine bits.

In one embodiment, the presence bitmap 1004 as shown in FIG. 10 can be a TID information presence bitmap and the Link/TID/AC information set 1006 is a TID information bitmap set where the LR presence bitmap indicates whether a corresponding TID information exists in the TID information bitmap set. Bits corresponding to MLDs are set to 0 if the buffered BUs only belong to TIDs mapped to the link in which the TIM/Beacon frame carrying the TIM element is transmitted; and set to 1 if the BUs of TIDs mapped to other links are also buffered.

The TID information presence bitmap carries a bit for every bit set to 1 in the TIM bitmap in the same order as in the TIM bitmap and the TID information bitmap set carries a TID information bitmap for every bit set to 1 in the TID information presence bitmap in the same order as in the TID information presence bitmap. Advantageously, when a bit set to 0 in the TID information presence bitmap for a non-AP MLD, the non-AP MLD only needs to retrieve BUs in the current link and no TID information bitmap is required in the TID information bitmap set, and the overhead of Link/TID/AC information is reduced.

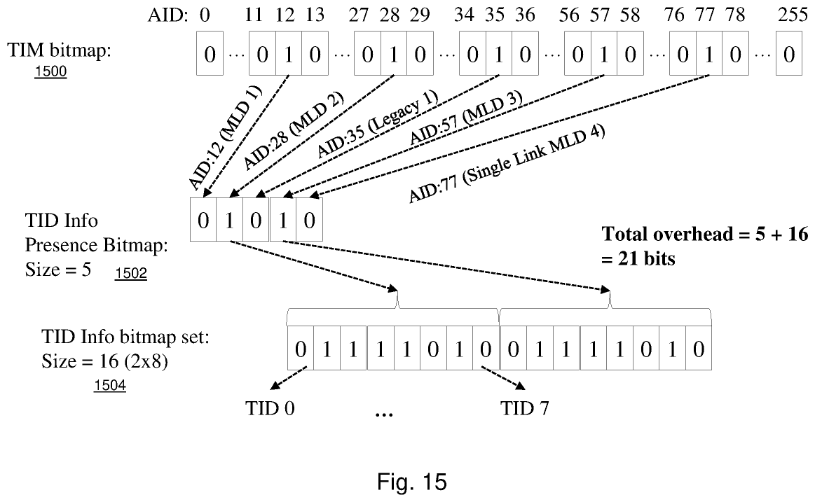

FIG. 15 depicts an example TIM bitmap 1500, a TID information presence bitmap 1502 and a TID information bitmap set 1506 in a TIM/Beacon frame. In the TIM bitmap 1500, TIM bits corresponding to AIDs of 12, 28, 35, 57 and 77 assigned to MLD 1, MLD 2, Legacy 1, MLD 3 and Single Link MLD 4 respectively are set to 1 indicating that the AP MLD has one or more buffered frame to transmit to those STA/MLDs. The TID information presence bitmap 1502 carries a bit for every bit set to 1 in the TIM bitmap 1500 in the same order as in the TIM bitmap, hence the TID information presence bitmap has a total size of five bits.

In this example, AP MLD transmitting the TIM/Beacon frame operates in three links (Link 1, Link 2 and Link 3) and the TIM/Beacon frame is transmitted in Link 1 (herein referred to current link). MLD 1 only has BUs of TIDs mapped to Link 1 while MLD 4 only operates on Link 1. As BUs of TIDs for MLD 1 and MLD 4 are mapped to the current link, no additional information for MLD1 and MLD 4 is required and TID information bitmap only exists or required for MLD 2 and MLD 3 in the TID information bitmap set 1504. The first bit and the fifth bit of the TID information presence bitmap 1502 corresponding to MLD 1 and MLD 4 are set to 0 to indicate that the buffered BUs for MLD 1 and MLD 4 only belong to TIDs mapped in the current link (Link 1); whereas the second bit and the fourth bit of the TID information presence bitmap 1502 corresponding to MLD 2 and MLD 3 are set to 1 to indicate that their BUs of TIDs mapped to other links (Link 2 and Link 3) are also buffered. Legacy 1 is a legacy STA, therefore the third bit of the TID information presence bitmap corresponding to Legacy 1 is always set to 0.

The TID information bitmap set 1504 carries a TID Information bitmap for every bit set to 1 in the TID information presence bitmap 1502 in the same order as in the TID information presence bitmap 1502. In this case, each TID information bitmap comprises eight bits corresponding to eight TIDs (TID 0-7), hence the TID information bitmap set 1504 has a total size of 16 bits. A bit in a TID information bitmap corresponding to a MLD is set to 1 if the BUs of that TID mapped to other links (Link 2, Link 3) is also buffered. In this case, the TID information bitmap of the TID information bitmap set 1504 is associated with MLD 2 and has its second to seventh bit (corresponding to TIDs 1-6) set to 1 indicating that BUs of TIDs 1-6 mapped to other links are also buffered. The total overhead of Link/TID/AC information using TID information presence bitmap 1502 (five bits) and TID information bitmap set 1504 (16 bits) in this case is 21 bits.

Alternatively, instead of TID information bitmap (8 bit), a single TID (3 bits) may be signaled in a similar manner described in FIG. 7 but only for bits for MLDs that are set to 1 in TID information presence bitmap 1502, in this case, for MLD 2 and MLD 3.

Also, in one embodiment, TID-to-link mapping is done per Access Category (AC), i.e. two TIDs of an AC are always mapped together to a link and they are never separately mapped to links. In such embodiment, the presence bitmap can be an AC information presence bitmap and the Link/TID/AC information set is an AC information bitmap set where the AC information presence bitmap indicates whether a corresponding AC information exists in the AC information bitmap set. Bits corresponding to MLDs are set to 0 if only BUs of TIDs of ACs mapped in the link in which the TIM/Beacon frame carrying the TIM element is transmitted (herein referred to as current link) are buffered; and set to 1 if the BUs of TIDs of ACs mapped to other links are also buffered. Advantageously, with a bit set to 0 in the AC information presence bitmap for a non-AP MLD, the non-AP MLD only needs to retrieve BUs in the current link.

The AC information presence bitmap carries a bit for every bit set to 1 in the TIM bitmap in the same order as in the TIM bitmap and the AC information bitmap set carries an AC information bitmap for every bit set to 1 in the AC information presence bitmap in the same order as in the AC information presence bitmap. Advantageously, a bit set to 0 in the AC information presence bitmap for a non-AP MLD, the non-AP MLD only needs to retrieve BUs in the current link and no AC information bitmap is required in the AC information bitmap set, and the overhead of Link/TID/AC information is reduced.

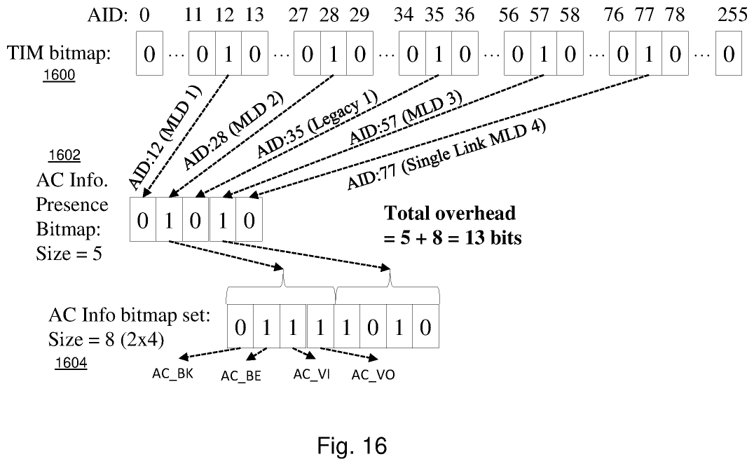

FIG. 16 depicts an example TIM bitmap 1600, an example AC information presence bitmap 1602 and an example AC information bitmap set 1604 in a TIM/Beacon frame. In the TIM bitmap 1600, TIM bits corresponding to AIDs of 12, 28, 35, 57 and 77 assigned to MLD 1, MLD 2, Legacy 1, MLD 3 and Single Link MLD 4 respectively are set to 1 indicating that the AP MLD has one or more buffered frame to transmit to those STA/MLDs. The AC information presence bitmap 1602 carries a bit for every bit set to 1 in the TIM bitmap 1600 in the same order as in the TIM bitmap 1600, hence the TID information presence bitmap 1602 has a total size of five bits.

In this example, AP MLD transmitting the TIM/Beacon frame operates in three links (Link 1, Link 2 and Link 3). and the TIM/Beacon frame is transmitted in Link 1 (herein referred to current link). There are four ACs, i.e. AC_BK, AC_BE, AC_VI and AC_VO. Two TIDs are mapped to each of the four ACs. An example AC-TID mapping is shown in table 1 below. The two TIDs of each AC is always mapped to a link. In this example, AC_VO and AC_VI are mapped to Link 1 and Link 2; whereas AC_BE and AC_BK are mapped to Link 3.

MLD 1 only has BUs of ACs mapped to Link 1 while MLD 4 only operates on Link 1. As BUs of ACs for MLD 1 and MLD 4 are mapped to the current link, no additional information for MLD1 and MLD 4 is required and AC information bitmap only exists or required for MLD 2 and MLD 3 in the AC information bitmap set 1604. The first bit and the fifth bit of the AC information presence bitmap 1602 corresponding to MLD 1 and MLD 4 are set to 0 to indicate that the only BUs of TIDs of ACs mapped in the current link (Link 1) are buffered; whereas the second bit and the fourth bit of the AC information presence bitmap 1602 corresponding to MLD 2 and MLD 3 are set to 1 to indicate that their BUs of ACs mapped to other links (Link 2 and Link 3) are also buffered. Legacy 1 is a legacy STA, therefore the third bit of the AC information presence bitmap 1602 corresponding to Legacy 1 is always set to 0.

TABLE 1
An example AC-TID mapping.

| AC | TID |
|---|---|
| AC_BK | 1 |
| | 2 |
| AC_BE | 0 |
| | 3 |
| AC_VI | 4 |
| | 5 |
| AC_VO | 6 |
| | 7 |

The AC information bitmap set 1604 carries an AC Information bitmap for every bit set to 1 in the AC information presence bitmap 1602 in the same order as in the AC information presence bitmap 1602. In this case, each AC information bitmap comprises four bits corresponding to four ACs (AC_BK, AC_BE, AC_VI, AC_VO), hence the AC information bitmap set 1604 has a total size of eight bits. The total overhead of Link/TID/AC information using AC information presence bitmap 1602 (five bits) and AC information bitmap set 1604 (four bits) in this case is 13 bits.

According to the present disclosure, different portions (e.g. AID spaces) of TIM bitmap may be reserved for assignments of AIDs to legacy STAs/non-MLD Extremely High Throughput (EHT) STAs and to non-AP MLDs, where the different portions do not overlap.

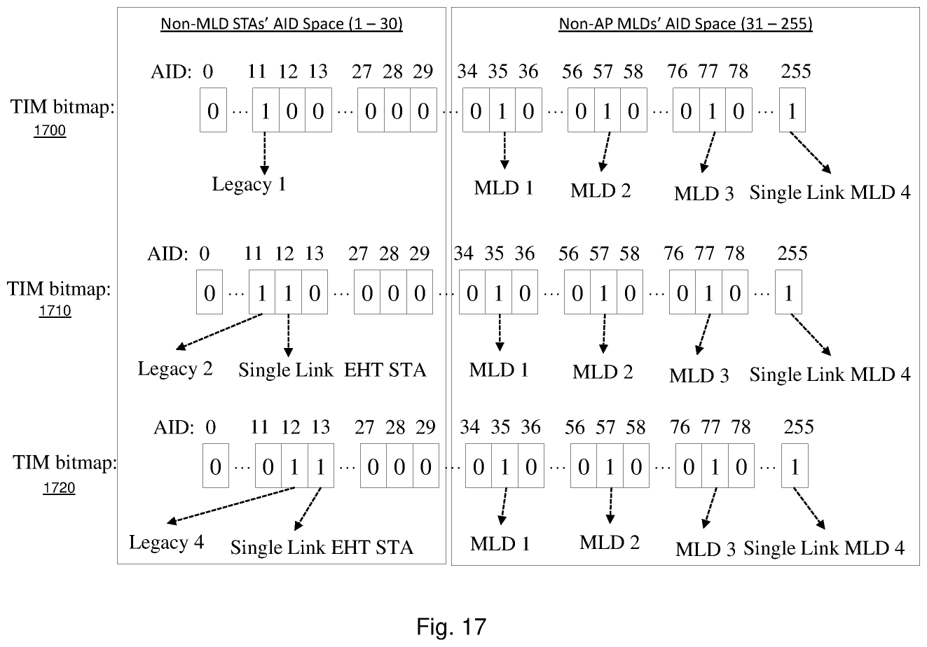

FIG. 17 depicts example AID assignments and three example TIM bitmaps 1700, 1710, 1720 transmitted in three links from an AP MLD, respectively. In this example, 255 consecutive AIDs are used by the AP MLD (out of maximum 2007) and first AID (0) are used to indicate group addressed frames and is not allocated to STAs; following 30 AIDs (1-30) are reserved for legacy STAs & single link EHT STAs and the remaining AIDs (31-255) are used for non-AP MLDs.

Each TIM bit is mapped to an AID. Accordingly, following the first TIM bit associated with AID 0, a following portion of the TIM bitmap (in this case, portion associated with AIDs 1-30) is reserved for legacy STAs and non-MLD EHT STAs (herein referred to as non-MLD STAs' AID space) and the remaining portion of the TIM bitmap is used for non-AP MLDs (herein referred to as non-AP MLDs' AID space). Advantageously, such AID assignment can also reduce overhead of Link/TID/AC information.

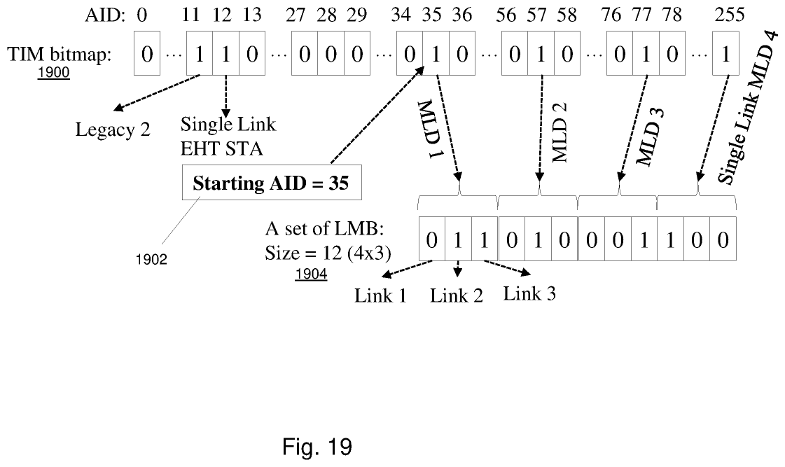

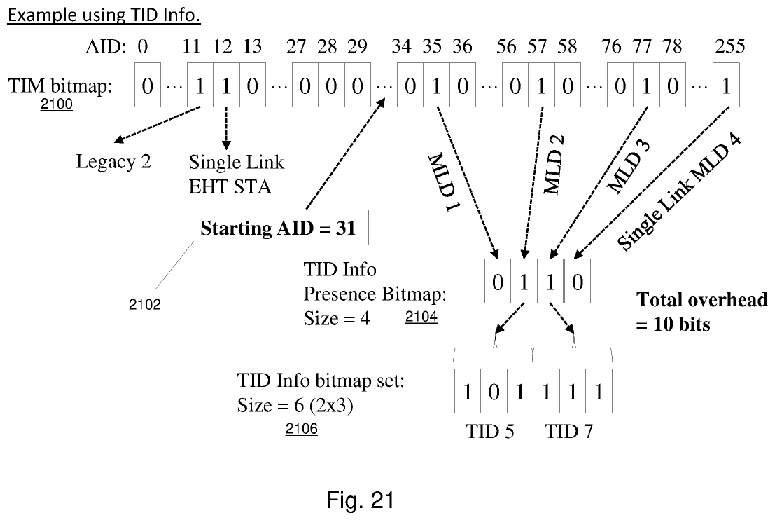

As such, with the AID assignment, Link/AID/AC information related to buffered BUs only exists for non-AP MLDs in Link/AID/AC information set. A Starting AID field can be used to indicate the AID of the first non-AP MLD (e.g. the smallest AID) in the non-AP MLDs' AID space whose Link/AID/AC information is included in the Link/TID/AC information set. Various embodiments of the present disclosure in the following descriptions with the accompanying FIGS. 19 and 21 are based on the example AID assignment used for the example TIM bitmap 1710.

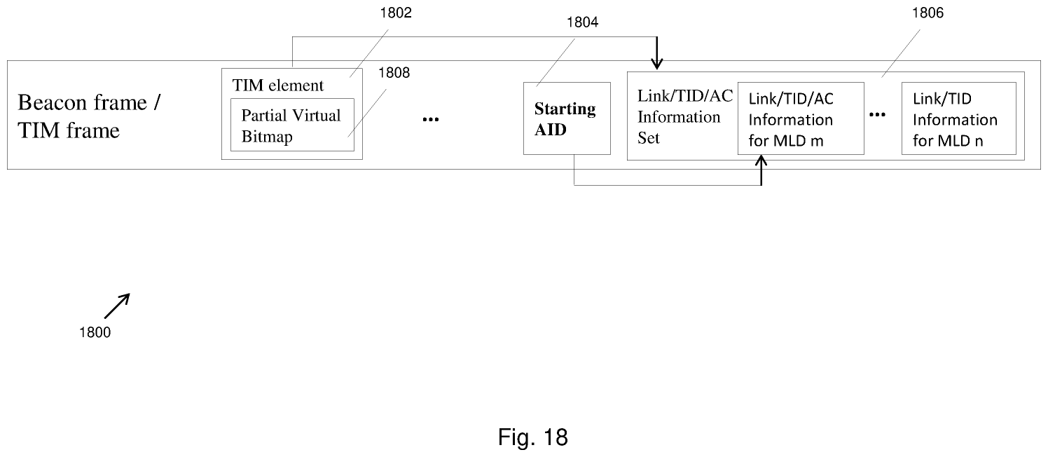

FIG. 18 depicts an example Beacon/TIM frame 1800. Although the format of Beacon/TIM frame is illustrated, it is appreciable that the same can be applied to a Fast Initial Link Setup (FILS) Discovery frame or an Operation (OPS) frame. The Beacon/TIM frame 1800 carries a TIM element 1802 comprising a Partial Virtual Bitmap (PVM) 1808, a Starting AID field 1804, a Link/TID/AC Information Set 1806 comprising Link/RID/AC information for each of associated MLDs.

FIG. 19 depicts a TIM bitmap 1900 and an example LMB set 1904 in a Beacon/TIM frame. In the TIM bitmap 1900, TIM bit is set to 1 if the AP MLD has one more buffered frame to transmit to the non-AP STA/MLD on any link to be used. TIM bits corresponding to AIDs of 11, 12, 35, 57, 77, 255 assigned to Legacy 2, Single Link EHT STA, MLD 1, MLD 2, MLD 3 and Single Link MLD 4 respectively are set to 1 indicating that the AP MLD has one or more buffered frame to transmit to those STA/MLDs.

A Starting AID field 1902 indicates a smallest AID assigned to a non-AP MLD for which TIM bit is set to 1, that is, Link/TID/AC information is present in the frame. In this case, the starting AID is 35. Through assignment of non-AP MLD AID space in TIM bitmap and starting AID, presence bitmap may not be required, hence the overhead of Link/TID/AC Information is reduced.

Based on the starting AID in the Starting AID field 1902 and the TIM bitmap 1900, non-AP MLDs can figure out the position of their corresponding Link/TID/AC information in the Link/TID/AC Information Set. In particular, the starting AID of 35 indicates that the first entry in the Link/TID/AC information set is associated with the non-AP MLD assigned to AID 35, which in this case is MLD 1.

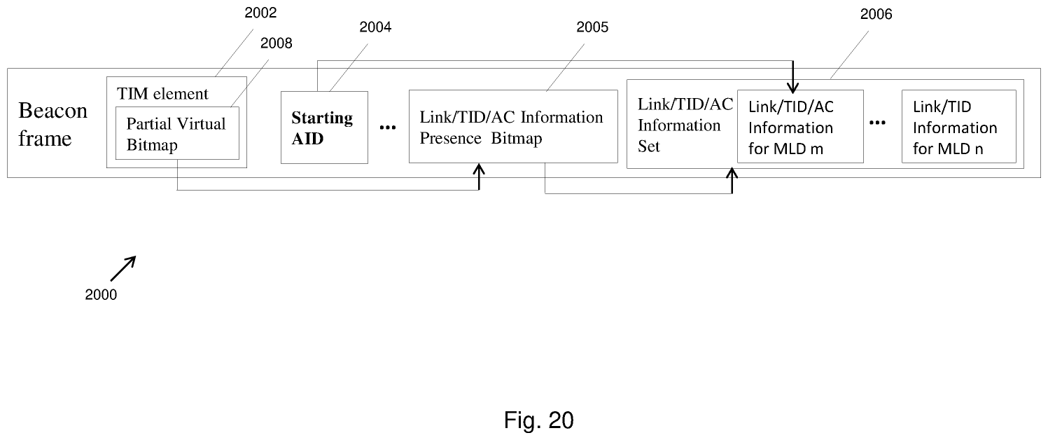

FIG. 20 depicts another example Beacon/TIM frame 2000. A Link/TID/AC Information Presence Bitmap 2005 can be used together with Starting AID field 2004 to further reduce the overhead of Link/TID/AC Information.

FIG. 21 depicts an example TIM bitmap 2100, an example TID information presence bitmap 2104 and an example TID information bitmap set 2106 in a Beacon/TIM frame. In the TIM bitmap 2100, TIM bits corresponding to AIDs of 11, 12, 35, 57, 77, 255 assigned to Legacy 2, Single Link EHT STA, MLD 1, MLD 2, MLD 3 and Single Link MLD 4 respectively are set to 1 indicating that the AP MLD has one or more buffered frame to transmit to those STA/MLDs. In this example, TIM is transmitted in Link 2 and the starting AID field 2102 is set to the start of the non-AP MLD's AID space (AID 31). The TID Info Presence Bitmap carries one bit each for a corresponding bit in the TIM bitmap that is set to 1 starting from the AID pointed by the starting AID field (i.e., 31). Through assignment of non-AP MLD AID space in TIM bitmap 2100 and starting AID 2102, TID information presence bitmap 2104 for non-MLD STAs' AID space (AID 1-30) is omitted, hence the overhead of Link/TID/AC Information is reduced.

In this example, MLD 1 only has BUs of TIDs mapped to Link 2 while MLD 4 only operates on Link 1 so TID information for MLD 4 is not included in Link 2. No additional information of buffered BUs for MLD1 and MLD 4 is required and TID information bitmap only exists or required for MLD 2 and MLD 3 in the TID information bitmap set 2106. The second bit and the third bit of the TID information presence bitmap 2104 corresponding to MLD 2 and MLD 3 are set to 1 to indicate that their BUs of TIDs mapped to other links are also buffered.

The TID information bitmap set carries a TID Information bitmap for every bit set to 1 in the TID information presence bitmap 2104 in the same order as in the TID information presence bitmap 2104. In this case, a single TID (3 bits) is signaled for each of MLD 2 and MLD 3, hence the TID information bitmap set 2106 has a total size of 6 bits. A 3-bit TID of 101 and 111 signals BUs of TID 5 and 7 are buffered for MLD 2 and MLD 3 respectively. If BUs exists for other TIDs, they are signaled in the A-control fields of the subsequent data frames belonging to the indicated TIDs.

In an embodiment, for APs that are members of a Multiple BSSID set (i.e. virtual APs), the bits 1 to (2\hat{ }n−1) of the TIM bitmap are used to indicate that one or more group addressed frames are buffered for each AP corresponding to a nontransmitted BSSID (virtual APs) and are called NonTxBSS identifiers (NonTxBSSIDs). These bits are not allocated to STAs in the BSS. In addition, some AIDs may also be reserved to signal the presence of group addressed BUs for other affiliated APs of the AP MLD and these AIDs may occur immediately after the AIDs assigned to virtual APs, if any. The AP MLD may also reduce the overhead of the Link/TID/AC Information for legacy STAs by proper planning of its AID space for associated non-AP STAs/MLDs. For example, the AP MLD may allocate AIDs to associated non-AP MLDs from the AID space that starts immediately after the last AID reserved for APs (e.g., 3), while the associated non-MLD STAs are allocated AIDs from AID Space that starts after the AID space reserved for non-AP MLDs.

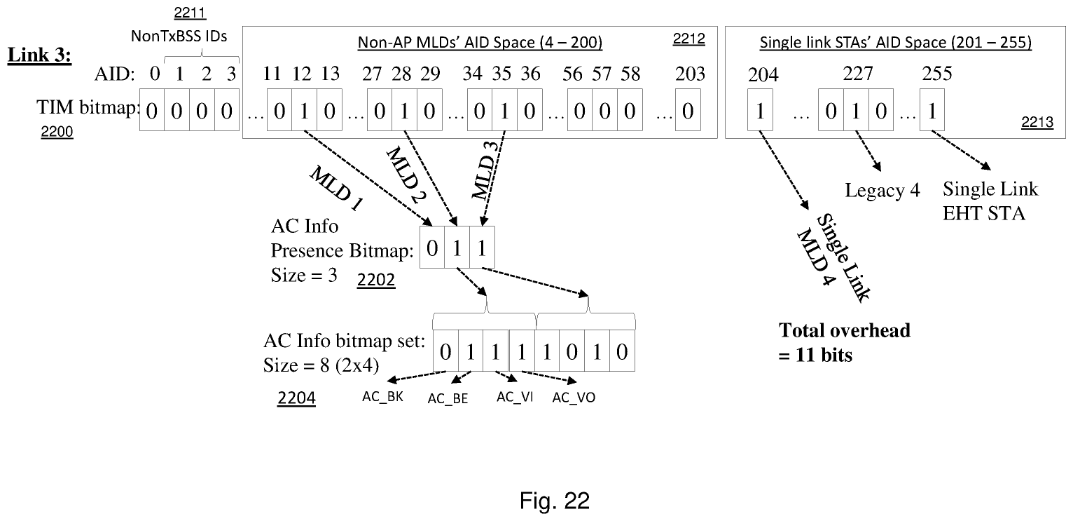

FIG. 22 depicts an example TIM bitmap 2200 transmitted in a link from an AP MLD and an example format of an AC information presence bitmap 2202 and an AC information bitmap set 2204. In this example, 255 consecutive AIDs are used by the AP MLD (out of maximum 2008) and first 4 AIDs (0-3) are used to indicate group addressed frames corresponding to 4 virtual APs; following 200 AIDs (4-203) are reserved for non-AP MLDs that operate on multiple links and the remaining AIDs (204-255) are used for legacy STAs & single link EHT STAs.

Each TIM bit is mapped to an AID. Accordingly, a beginning portion 2211 of the TIM bitmap 2202 (in this case, TIM bits associated with AIDs 0-3) is reserved for AP MLD (herein referred to as AP MLD's AID space). Following the AP MLD's AID space 2211, a following portion 2212 of the TIM bitmap (in this case, portion associated with AIDs 11-203) is reserved for non-AP MLD (herein referred to as non-AP MLDs' AID space) and the remaining portion 2213 of the TIM bitmap is reserved for legacy STAs and non-MLD EHT STAs (herein referred to as non-MLD STAs' AID space).

The non-AP MLDs' AID space 2212 starts immediately (appended to) the AID space 2211 reserved for APs in the TIM bitmap 2200. Single link MLDs (e.g. Single Link MLD 4 in FIG. 22) can also be assigned AIDs from the non-MLD STA's AID space, such that the non-AP MLD's AID space 2212 is exclusively reserved for non-AP MLDs that operate on multiple links. Instead of having fixed AID spaces, it is also possible that the AID space boundary is not clearly defined. For example, the non-AP MLDs that operate on multiple links are assigned AIDs consecutively starting from the first available AID (e.g. 4, 5, 6, . . . etc.), while the legacy STAs & single link EHT STAs are assigned AIDs consecutively starting backward from the last AID in the AP's AID space (e.g. 255, 254, 253 . . . etc.). Advantageously, as the AID space reserved for APs, e.g. NonTxBSS IDs, is known to all associated STAs, the starting AID is known and may be omitted in this scheme.

Returning to FIG. 22, with the AID assignment, Link/AID/AC information related to buffered BUs only exists for non-AP MLDs while legacy STAs and non-MLD EHT STAs are not included in Link/AID/AC information set, hence the presence bitmap only needs bits for non-AP MLDs. TIM bits corresponding to AIDs of 12, 28, 35, 56, 204, 227, 225 assigned to MLD 1, MLD 2, MLD 3, Single Link MLD 4, MLD 1, MLD 2, MLD 3 and Single Link MLD 4 respectively are set to 1 indicating that the AP MLD has one or more buffered frame to transmit to those STA/MLDs. In this example, TIM is transmitted in Link 3. MLD 1 only has BUs of TIDs mapped to Link 3 while MLD 4 only operates on Link 1 so AC information for MLD 4 is not included. No additional information of buffered BUs for MLD1 and MLD 4 is required and AC information bitmap only exists or required for MLD 2 and MLD 3 in the AC information bitmap set 2204. The second bit and the third bit of the TID information presence bitmap 2202 corresponding to MLD 2 and MLD 3 are set to 1 to indicate that their BUs of ACs mapped to other links are also buffered.

The AC information bitmap set 2204 carries an AC Information bitmap for every bit set to 1 in the AC information presence bitmap 2202 in the same order as in the AC information presence bitmap 2202. In this case, each AC information bitmap comprises four bits corresponding to four ACs (AC_BK, AC_BE, AC_VI, AC_VO), hence the AC information bitmap set 2204 has a total size of eight bits. The total overhead of Link/TID/AC information using AC information presence bitmap (three bits) and AC information bitmap set (eight bits) is 11 bits.

Yet in another embodiment, even without any restrictions on the AID assignment, an indication of a starting AID, e.g. using Starting AID field, may be used to help to reduce overhead of Link/TID/AC information by excluding STAs with AIDs lesser than the starting AID. The excluded STAs may be legacy STAs, non-MLD EHT STAs and even MLDs for which no Link/TID/AC information exists.

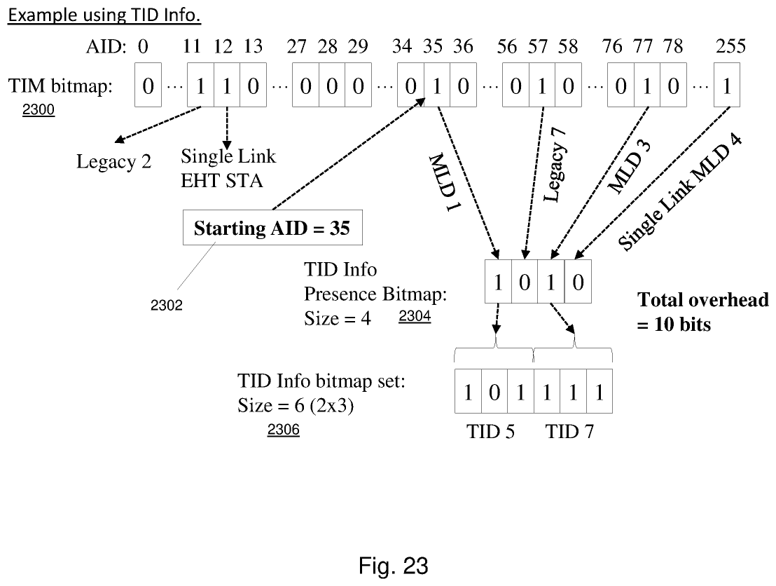

FIG. 23 depicts an example TIM bitmap 2300 and an example TID information presence bitmap 2304 and an example TID information bitmap set 2306 in a Beacon/TIM frame. TIM bits corresponding to AIDs of 11, 12, 35, 57, 77, 255 assigned to Legacy 2, Single Link EHT STA, MLD 1, Legacy 7, MLD 3 and Single Link MLD 4 respectively are set to 1 indicating that the AP MLD has one or more buffered frame to transmit to those STA/MLDs. Without any restrictions on AID assignment, AIDs of legacy STAs (e.g. Legacy 7) and AIDs of on-AP MLDs may get mixed. A starting AID field 2302 can indicate the AID of the first non-AP MLD (i.e. the smallest AID associated with a non-AP MLD) for which Link/TID/AC information is included in the Link/TID/AC information set. In this case, the Starting AID field 2302 indicates a starting AID of 35. This helps to exclude Legacy 2 and Legacy 3 from TID information bitmap set. Legacy STAs and non-MLD EHT STAs are still included in the Link/TID/AC information set, but only those with AIDs higher than that the starting AID (e.g. Legacy 7).

The TID information presence bitmap 2304 carries a bit for every bit set to 1 in the TIM bitmap in the same order as in the TIM bitmap 2300, hence the TID information presence bitmap 2304 has a total size of four bits. In this case, the first bit and the third bit corresponding to MLD 1 and MLD 3 are set to 1 in the TID information presence bitmap 2304. The TID information bitmap set 2306 carries an TID Information bitmap (a single TID with 3 bits in this case) for every bit set to 1 in the TID information presence bitmap 2304 in the same order as in the TID information presence bitmap 2304. In this case, the first bit and the third bit corresponding to MLD 1 and MLD 3 are set to 1 in the TID information presence bitmap, hence the TID information bitmap set 2306 has a size of six bits. The total overhead of Link/TID/AC information using TID information presence bitmap 2304 (four bits) and TID information bitmap set 2306 (six bits) in this case is 10 bits.

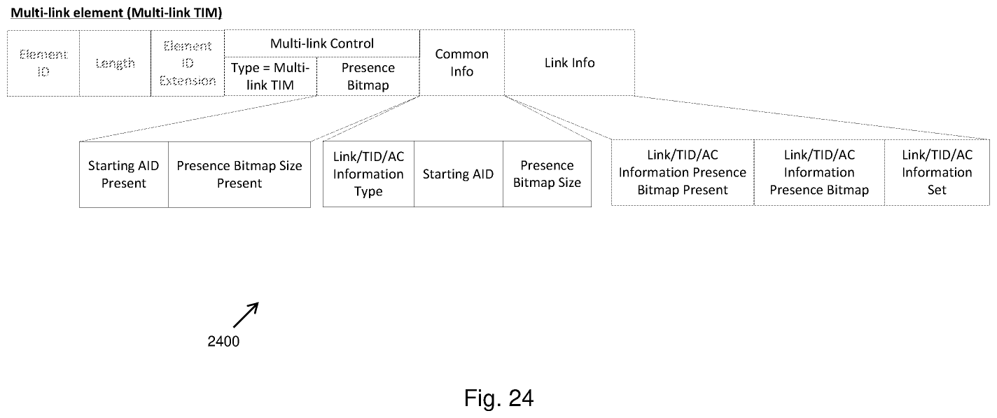

FIG. 24 depicts an example format of Multi-link TIM element 2400. The Multi-link TIM 2400 can be either a new element or a multi-link element with a type field set to “multi-link TIM” defined to carry a presence bitmap and Link/TID/AC information set. The Multi-link TIM element comprises an Element field, a Length field, an Element ID Extension field, a Multi-link Control field comprising the Type field (set to “Multi-link TIM”) and a Presence Bitmap, a Common Info field and a Link Info field.

The Presence Bitmap field of the Multi-link Control field further comprises a Starting AID Present field and a Presence Bitmap Size Present field that are used to indicate the presence of the Starting AID field and the Presence Bitmap Size field in the Common Info field. The Common Info field further comprises a Link/TID/AC Information Type field, a Starting AID field and a Presence Bitmap Size field. The Link Info field further comprises a Link/TID/AC Information Presence Bitmap Present field, a Link/TID/AC Information Presence Bitmap and a Link/TID/AC Information Set field. The Link/TID/AC Information Type field refers to what type of information is carried in the Link/TID/AC Information Set field as illustrated in table 2 below. The Presence Bitmap Size field indicates the size of the Link/TID/AC information Presence Bitmap.

The Link/TID/AC Information Presence Bitmap field indicates if further information about buffered BUs is present in the Link/TID/AC information and is set for non-AP MLDs. The Link/TID/AC Information Set field carries further information about the buffered BU for each of the non-AP MLDs.

According to the present disclosure, assuming different AID spaces are reserved for allocation of AIDs to legacy STAs (11n, 11ac, 11ax STAs) and EHT devices (non-MLD EHT non-AP STAs as well as non-AP MLDs), a separate TIM element, e.g. the existing baseline TIM element, can be used exclusively to signal buffered BUs for the legacy STAs while a new multi-link TIM bitmap is included in Multi-link TIM element to signal buffered BUs exclusively for the EHT devices. AIDs used to indicate group address BUs (for example AID 0, NonTxBSS IDs or an AP MLD's AID space) are duplicated in both TIM bitmap for legacy STAs and multi-link TIM bitmap for EHT devices.

TABLE 2
Values of in Link/TID/AC Information Type field and their
corresponding information type.
Information Type field Values

| Value | Meaning |
|---|---|
| 0 | Link Mapping Bitmap (LMB) |
| 1 | Link Recommendation (LR) |
| 2 | Link-set Bitmap (LSB) |
| 3 | LSB + LR |
| 4 | TID Bitmap |
| 5 | TID |
| 6 | AC |
| 7~255 | Reserved |

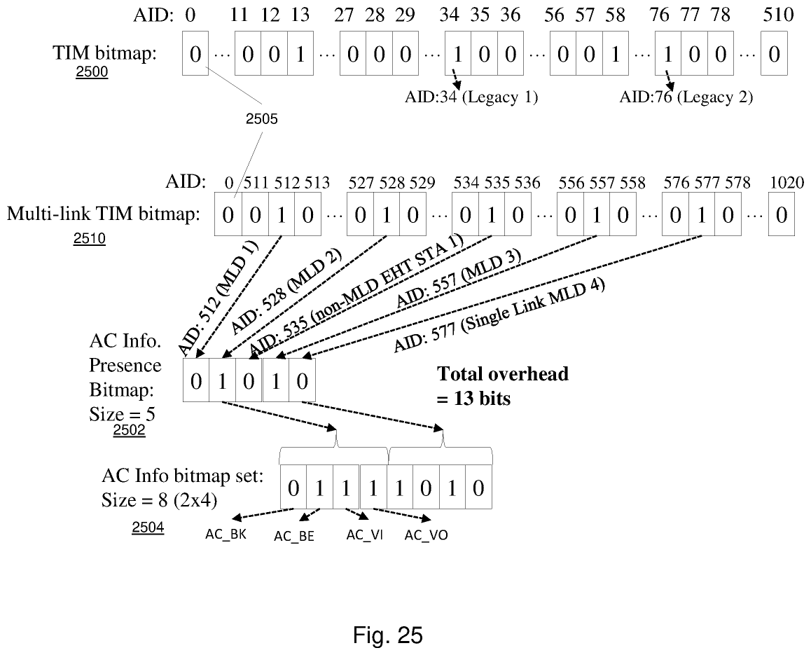

FIG. 25 depicts an example TIM bitmap 2500 and an example multi-link TIM bitmap 2510, an example AC information presence bitmap and an example AC information bitmap set in a Beacon/TIM frame. In this example, 1020 consecutive AIDs are used by the AP MLD (out of maximum 2008). 510 consecutive AIDs (1-510) are reserved for legacy STAs and the remaining AIDs (511-1020) are used EHT devices. Accordingly, The TIM bitmap 2500 is used to indicate buffered BUs exclusively for legacy devices, in this case Legacy 1 and Legacy 2 assigned under AID 34 and 76 respectively, and the multi-link TIM bitmap 2510 is used to indicate buffered BUs exclusively for EHT devices such as MLD 1, MLD 2, non-MLD EHT STA 1, MLD 3 and Single Link MLD 4 assigned under AIDs 51, 528, 535, 557 and 577 respectively. AID used to indicate group address BUs, in this case AID 0 is duplicated in the multi-link TIM bitmap, as indicated by 2505.

Legacy STAs only need to decode the TIM bitmap 2500; while EHT STAs only need to decode the Multi-link TIM bitmap 2510. The bit immediately after the duplicated bit(s) 2505 used to indicate group/broadcast addressed frames in the Multi-link bitmap corresponds to the first AID in the AID space reserved for EHT devices. To avoid duplication of bits in the TIM bitmaps, different AID spaces may be reserved for allocation of AIDs to legacy STAs and EHT devices.

As a variation, all non-MLD STAs can also be assigned AIDs from the legacy STA's AID space and baseline TIM can be used to indicate buffered BUs for non-MLD STAs. Non-MLD STAs refer to legacy STAs as well as EHT STAs that are not affiliated with an MLD.

As a further variation, single link MLDs can also be assigned AIDs from the legacy STA's AID space, such that the legacy STA's AID space is exclusively reserved for legacy STAs as well as all EHT devices that operate on a single link and baseline TIM can be used to indicate buffered BUs for single link MLDs as well. In this case the Multi-link Tim bitmap is exclusively used to indicate buffered BUs for non-AP MLDs only.

The AC information presence bitmap 2502 carries a bit for every bit set to 1 in the Multi-link TIM bitmap 2510 in the same order as in the Multi-link TIM bitmap 2510, hence the AC information presence bitmap 2502 has a total size of five bits. The AC information bitmap set 2504 carries an AC Information bitmap for every bit set to 1 in the AC information presence bitmap 2502 in the same order as in the AC information presence bitmap 2502. Each AC information bitmap comprises four bits corresponding to four ACs. In this case, the first bit and the fourth bit corresponding to MLD 2 and MLD 3 are set to 1 in the AC information presence bitmap 2502, hence the AC information bitmap set has a size of eight bits. The total overhead of Link/TID/AC information using separate TIM element for EHT device, AC information presence bitmap 2502 (five bits) and AC information bitmap set 2504 (eight bits) in this case is 13 bits.

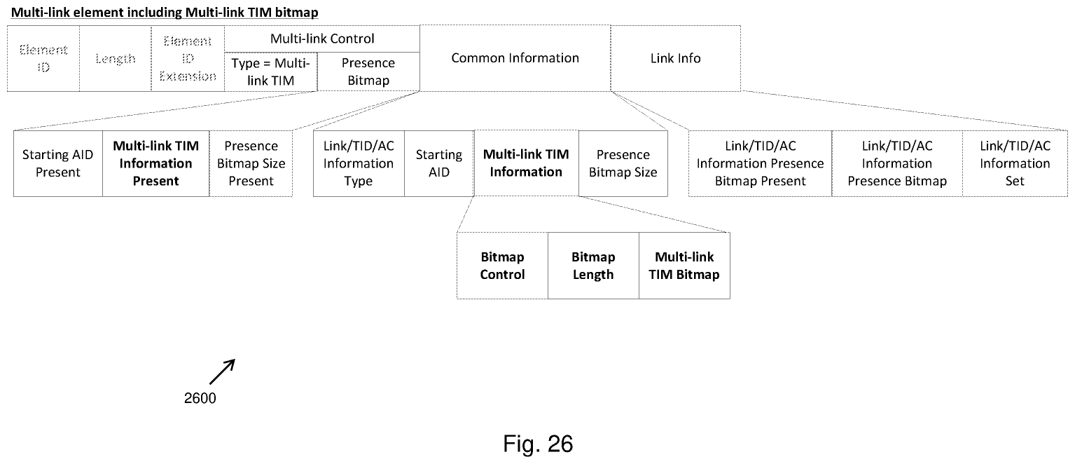

FIG. 26 depicts an example format of Multi-link TIM element 2600 including a Multi-link TIM bitmap. The Multi-link TIM 2600 comprises an Element field, a Length field, an Element ID Extension field, a Multi-link Control field comprising a Type field set to “Multi-link TIM” and a Presence Bitmap field, a Common Info field and a Link Info field.

The Presence Bitmap field of the Multi-link Control field further comprises a starting AID Present field, a Multi-link TIM Information Present field and a Presence Bitmap Size Present field that are used to indicate the presence of the Starting AID field, the Multi-link TIM Information field and the Presence Bitmap Size field in the Common Info field. The Common Info field further comprises Link/TID/AC Information Type field, a starting AID field, a Multi-link TIM Information field and a Presence Bitmap Size field. The Link Info field further comprises a Link/TID/AC Information Presence Bitmap Present field, a Link/TID/AC Information Presence Bitmap field and a Link/TID/AC Information Set field. The Multi-Link TIM Information field further comprises a Bitmap Control field, a Bitmap Length field and a Multi-link TIM Bitmap field. The Bitmap Control field has a same function as the Bitmap control field in legacy TIM element as described and illustrated in FIG. 24. The Bitmap Length field indicates a length of the Multi-link bitmap in octets. The Multi-Link TIM Bitmap field indicates buffered BUs exclusively for EHT device or for non-AP MLD. The Link/TID/AC Information Type field refers to what type of information is carried in the Link/TID/AC Information Set field in a similar way illustrated in table 2 above. The Link/TID/AC Information Presence Bitmap field indicates if further information about buffered BUs is present in the Link/TID/AC information and is set for non-AP MLDs. The Link/TID/AC Information Set field carries further information about the buffered BU for each of the non-AP MLDs.

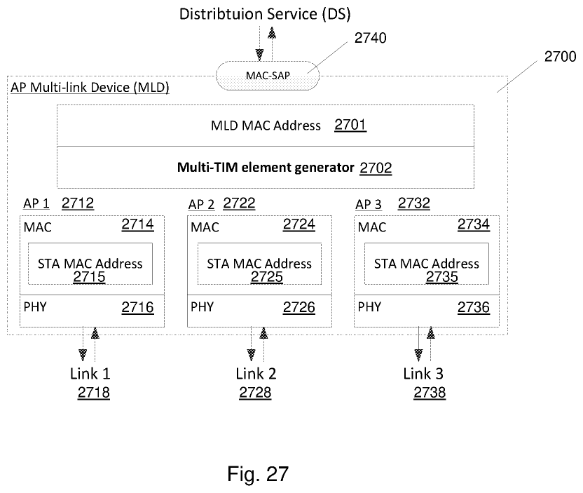

FIG. 27 shows an example configuration of a communication device 2700 and three communication apparatuses 2712, 2722, 2732 affiliated with the communication device 2700. The communication device 2700 is implemented as an AP MLD and each of the affiliated communication apparatuses 2712, 2722, 2732 may be implemented as an AP configured for multi-link traffic indication map according to various embodiments in the present disclosure. The communication device 2700 comprises a multi-TIM element generator 2702 configured to perform multi-link traffic indication mapping according to above-mentioned embodiments, such as generating a multi-link TIM element and presence bitmap with a starting AID field, the multi-link TIM element comprising a partial virtual bitmap (PVM) indicating presence of one or more buffered units for external communication apparatuses/devices associated with the communication apparatuses, the presence bitmap indicating whether additional information (e.g. Link/TID/AC information) relating to the one or more BUs is present for the associated external communication apparatuses/devices.

The communication device 2700 comprises a storage module storing its MLD MAC MLD address 2701. The communication device 2700 further comprises a MAC SAP 2740 used for communicating with an Internet layer and/or DS. Each of the communication apparatuses 2712, 2722, 2732 affiliated with the communication device offering a link 2718, 2728, 2738 to associated with and capable of transmitting (e.g. transmitting frames comprising the multi-link TIM element and the presence bitmap with the starting AID-related field relating to a starting AID) to or receiving other signals from other external communication apparatuses/devices and/or the DS. Each affiliated communication apparatus 2712, 2722, 2732 comprises a MAC layer 2714, 2724, 2734 and a PHY (physical) layer 2716, 2726, 2736, the PHY layer connecting with a radio transmitter, a radio receiver and an antenna used for transmitting/receiving signal to/from other communication apparatuses/devices through a corresponding link 2718, 2728, 2738. In an embodiment, the MAC layer comprises a storage module storing its AP MAC address 2715, 2725, 2735 and an optional AP MAC SAP for direct communication with the Internet layer for traffic to/from legacy STAs.

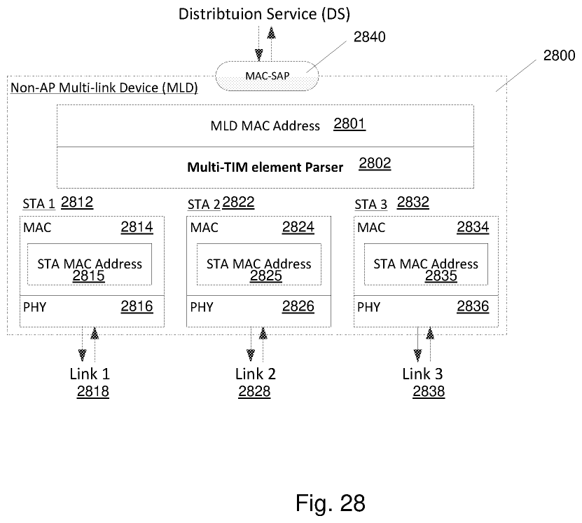

FIG. 28 shows an example configuration of a communication device 2800 and three communication apparatuses 2812, 2822, 2832 affiliated with the communication device 2800. The communication device 2800 is implemented as a non-AP MLD and each of the affiliated communication apparatuses 2812, 2822, 2832 may be implemented as a STA configured for multi-link traffic indication map according to various embodiments in the present disclosure. The communication device 2800 further comprises a Multi-TIM element Parser 2802 configured to perform multi-link traffic indication mapping according to above-mentioned embodiments such as receiving and processing a multi-link TIM element and presence bitmap with a starting AID field, the multi-link TIM element comprising a partial virtual bitmap (PVM) indicating presence of one or more buffered units for the communication device 2700, the presence bitmap indicating whether additional information (e.g. Link/TID/AC information) relating to the one or more BUs is present for the communication device 2800.

The communication device 2800 comprises a storage module storing its MLD MAC MLD address 2801. The communication device 2800 further comprises a MAC SAP 2840 used for communicating with an Internet layer and/or DS. Each of the communication apparatuses 2812, 2822, 2832 affiliated with the communication device offering a link 2818, 2828, 2838 to associated with and capable of receiving/transmitting other signals from other external communication apparatuses/devices and/or the DS. Each affiliated communication apparatus 2812, 2822, 2832 comprises a MAC layer 2814, 2824, 2834 and a PHY (physical) layer 2816, 2826, 2836, the PHY layer connecting with a radio transmitter, a radio receiver and an antenna used for transmitting/receiving signal to/from other communication apparatuses/devices through a corresponding link 2818, 2828, 2838. In an embodiment, the MAC layer comprises a storage module storing its STA MAC address 2815, 2825, 2835 and an optional STA MAC SAP for direct communication with the Internet layer for traffic to/from legacy AP/STAs.

The present disclosure can be realized by software, hardware, or software in cooperation with hardware. Each functional block used in the description of each embodiment described above can be partly or entirely realized by an LSI (large-scale integration) such as an integrated circuit, and each process described in each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration. However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing. If future integrated circuit technology replaces LSIs as a result of the advancement of semiconductor technology or other derivative technology, the functional blocks could be integrated using the future integrated circuit technology. Biotechnology can also be applied.

The present disclosure can be realized by any kind of apparatus, device or system having a function of communication, which is referred as a communication device.

Some non-limiting examples of such communication device include a phone (e.g., cellular (cell) phone, smart phone), a tablet, a personal computer (PC) (e.g., laptop, desktop, netbook), a camera (e.g., digital still/video camera), a digital player (digital audio/video player), a wearable device (e.g., wearable camera, smart watch, tracking device), a game console, a digital book reader, a telehealth/telemedicine (remote health and medicine) device, and a vehicle providing communication functionality (e.g., automotive, airplane, ship), and various combinations thereof.

The communication device is not limited to be portable or movable, and may also include any kind of apparatus, device or system being non-portable or stationary, such as a smart home device (e.g., an appliance, lighting, smart meter, control panel), a vending machine, and any other “things” in a network of an “Internet of Things (IoT)”.

The communication may include exchanging data through, for example, a cellular system, a wireless LAN system, a satellite system, etc., and various combinations thereof.

The communication device may comprise an apparatus such as a controller or a sensor which is coupled to a communication apparatus performing a function of communication described in the present disclosure. For example, the communication device may comprise a controller or a sensor that generates control signals or data signals which are used by a communication apparatus performing a communication function of the communication device.

The communication device also may include an infrastructure facility, such as a base station, an access point, and any other apparatus, device or system that communicates with or controls apparatuses such as those in the above non-limiting examples.

A non-limiting example of a station may be one included in a first plurality of stations affiliated with a multi-link station logical entity (i.e. such as an MLD), wherein as a part of the first plurality of stations affiliated with the multi-link station logical entity, stations of the first plurality of stations share a common medium access control (MAC) data service interface to an upper layer, wherein the common MAC data service interface is associated with a common MAC address or a Traffic Identifier (TID).

Thus, it can be seen that the present embodiments provide communication devices and methods for operation over multiple links in order to fully realize the throughput gains of multi-link communication, in particular for multi-link secured retransmissions.

While exemplary embodiments have been presented in the foregoing detailed description of the present embodiments, it should be appreciated that a vast number of variations exist. It should further be appreciated that the exemplary embodiments are examples, and are not intended to limit the scope, applicability, operation, or configuration of this disclosure in any way. Rather, the foregoing detailed description will provide those skilled in the art with a convenient road map for implementing exemplary embodiments, it being understood that various changes may be made in the function and arrangement of steps and method of operation described in the exemplary embodiments and modules and structures of devices described in the exemplary embodiments without departing from the scope of the subject matter as set forth in the appended claims.

1-16. (canceled)

17. An Access Point (AP) of a plurality of APs affiliated with an AP multi-link device (MLD), each of the plurality of APs operating in a corresponding link of the AP MLD, the AP comprising:
circuitry, which in operation, generates a frame comprising a traffic indication map (TIM) element and information, the TIM element comprising a partial virtual bitmap (PVM) indicating presence of one or more buffered units for one of a non-AP STA or a non-AP MLD associated with the AP or the AP MLD, the information indicating a smallest AID for which additional information relating to one or more BUs is present in the frame; and
a transmitter, which in operation, transmits the frame in a link.

18. The AP according to claim 17, wherein the frame comprises a presence bitmap which indicates whether additional information relating to the one or more BUs is present in the frame for the one of the non-AP STA or the non-AP MLD.

19. The AP according to claim 17, wherein the additional information comprises at least one of a Link Mapping Bitmap (LMB), a Link Recommendation (LR), a Link-set Bitmap (LSB), a Traffic Identifier (TID) Bitmap, an Access Category (AC) Bitmap, a TID and an AC.

20. The AP according to claim 17, wherein a first portion of the PVM in the TIM element is associated with AIDs assigned to legacy STAs and non-MLD Extremely High Throughput (EHT) STAs and a second portion of the PVM in the TIM element is associated with AIDs assigned to non-AP MLDs, wherein the first portion and the second portion of the TIM element do not overlap.

21. The AP according to claim 20, wherein the second portion of the PVM in the TIM element associated with AIDs assigned to non-AP MLDs starts immediately after a third portion of the PVM in the TIM element associated with AIDs assigned to APs and the first portion.

22. The AP according to claim 17, wherein the frame is one of a Beacon frame, a TIM frame, a Fast Initial Link Setup (FILS) Discovery frame and Operation (OPS) frame.

23. The AP according to claim 17, wherein a PVM for non-AP MLDs and a PVM for non-AP STAs that are affiliated with MLDs are carried in different TIM elements.

24. A communication method, comprising:
generating a frame comprising a traffic indication map (TIM) element and information, the TIM element comprising a partial virtual bitmap (PVM) indicating presence of one or more buffered units for one of a non-AP STA or a non-AP MLD associated with a AP or an AP MLD, the information indicating a smallest AID for which additional information relating to one or more BUs is present in the frame; and
transmitting the frame in a link.
